(19) United States
(12) Patent Application Publication
(10) Pub. No.: US 2016/0036899 A1
(43) Pub. Date: Feb. 4, 2016

(54) SYSTEMS, METHODS, AND APPARATUSES FOR IMPLEMENTING AN INCIDENT RESPONSE INFORMATION MANAGEMENT SOLUTION FOR FIRST RESPONDERS

(71) Applicants: Daniel E. B. Moody, Santa Barbara, CA (US); Lawrence A. H. Moody, Santa Barbara, CA (US); Christopher W. L. Wells, Domjean (FR)

(72) Inventors: Daniel E. B. Moody, Santa Barbara, CA (US); Lawrence A. H. Moody, Santa Barbara, CA (US); Christopher W. L. Wells, Domjean (FR)

(73) Assignee: STRAWBERRY MEDIA, INC., Santa Barbara, CA (US)

(21) Appl. No.: 14/884,624

(22) Filed: Oct. 15, 2015

Related U.S. Application Data
(63) Continuation-in-part of application No. 14/331,895, filed on Jul. 15, 2014.
(60) Provisional application No. 61/846,220, filed on Jul. 15, 2013.

(51) Int. Cl. H04L 29/08; G06F 3/0482; G06F 3/0481; G08B 25/00; G06F 17/30

(52) U.S. Cl. CPC H04L 67/10; G08B 25/007; G06F 17/30864; G06F 3/04817; G06F 3/0482; H04L 67/141

(57) ABSTRACT

Described herein are methods and systems for implementing an incident response information management solution for First Responders. In one embodiment, such means include a system having at least a processor and a memory therein, in which the system includes means for establishing a first communications link between a first client device and the system over a network, the first client device being associated with a first emergency response person; means for displaying an interface at the first client device from the system; means for identifying an emergency response incident type at the first client device via the interface; means for generating an incident response record at the system responsive to the identifying of the emergency response incident type at the first client device; means for establishing a second communications link between a second client device and the system over the network, the second client device being associated with a second emergency response person; means for displaying the interface at the second client device from the system; means for displaying emergency response information at the interface of the second client device selected based on the emergency response incident type identified at the first client device, in which the emergency response information is communicated from the system to the second client device over the network; and means for receiving incident metrics at the system captured via the interface at the second client device and recording the incident metrics within the incident response record. Other related embodiments are further described.

### CLAIM OF PRIORITY

This continuation-in-part application is related to, and claims priority to, the utility application entitled “SYSTEM, METHODS, & APPARATUSES FOR IMPLEMENTING AN ACCIDENT SCENE RESCUE, EXTRACTION AND INCIDENT SAFETY SOLUTION,” filed on Jul. 15, 2014, having an application number of Ser. No. 14/331,895 and Attorney Docket No. 9819P001; and the provisional utility application entitled “SYSTEMS, METHODS, AND APPARATUSES FOR IMPLEMENTING AN ACCIDENT SCENE RESCUE, EXTRACTION, AND INCIDENT SAFETY SOLUTION,” filed on Jul. 15, 2013, having an application number of 61/846,220 and Attorney Docket No. 9819P001Z, the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments of the invention relate generally to the field of computing, and more particularly, to methods and systems for implementing an accident scene rescue, extrication, and incident safety solution. Additionally disclosed embodiments of the invention also relate generally to the field of computing, and more particularly, to methods and systems for implementing an incident response information management solution for First Responders.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to embodiments of the claimed inventions.

There are approximately 254 million cars on the road in the United States. Each year, approximately 10 million of these cars are involved in accidents and approximately, six percent of these accidents will require the use of an extrication tool. As technology has evolved, First Responders must adapt to changing on-scene circumstances. During extrication first responders risk cutting fuel lines, triggering unwanted airbag deployments and in recent years, must now perform extrication on hybrid cars having more than 700 volts of electricity flowing throughout the electrical system. If a First Responder cuts into the electrical lines of a hybrid car they may kill themselves and the passenger of the car. When a First Responder arrives on the scene of an accident, they are faced with any one of thousands of different vehicle models, each one with its own design and security features. First Responders simply do not have time to read every instruction manual that directs the varied passenger extrication processes from a diverse market of vehicles. Consequently, firefighters must balance the time-sensitive nature of extrication with limited knowledge of a particular vehicle model very often requiring they assess where to cut into a car during the extrication process thus endangering their own lives and the lives of the passengers.

The present state of the art may therefore benefit from the methods and systems for implementing an accident scene rescue, extrication, and incident safety solution as are taught herein.

Other problems face First Responders responding to a variety of incidents beyond those limited to motor vehicle accidents including, for example, fires, hazardous material incident response, medical emergencies, flooding, industrial accidents, explosions, and so forth. These kinds of incidents are more varied, potentially more dynamic in nature, often require a much larger response team of First Responders, and by their nature, implicate a variety of procedures and protocol.

Problematically, conventional methodologies require that all information pass through what is essentially a human bottleneck, requiring that decisions, protocols, deployments, task assignments, roles, and procedure pass through a centralized incident commander acting as a kind of information hub who then in turn passes relevant information, commands, instructions, deployments, tasks, etc., to the First Responders, each of whom form a kind of spoke emanating from the center hub.

The First Responders then execute pursuant to the centralized incident commander, but the structure is extremely rigid and fails to account for the dynamicism common to such public safety incidents. Additionally, requiring that all information pass through the single point of contact, which is literally a human operating as the centralized incident commander, creates a bottleneck which only worsens with the scale of incident response required.

Yet further still, the First Responders are burdened with cumbersome and archaic reporting procedures and their entire industry lacks a modern era information management structure which caters to the peculiar nature of their jobs and function as incident First responders.

The present state of the art may therefore benefit further still from the methods and systems for implementing methods and systems for implementing an incident response information management solution for First Responders as is described herein.

### BRIEF DESCRIPTION OF THE DRAWINGS

Embodiments are illustrated by way of example, and not by way of limitation, and can be more fully understood with reference to the following detailed description when considered in connection with the Diagrams, Figures, and Appendices in which:

FIG. 1 depicts an exemplary architecture in accordance with described embodiments;

FIG. 2 depicts an alternative exemplary architecture in accordance with described embodiments;

FIG. 3 depicts a series of layered images utilized in conjunction with described embodiments;

FIG. 4 is a flow diagram illustrating a method for implementing an accident scene rescue, extrication, and incident safety solution in accordance with disclosed embodiments;

FIG. 5 shows a diagrammatic representation of a computing device within which embodiments may operate, be installed, integrated, or configured;

FIG. 6 depicts an exemplary graphical interface operating at a mobile, smartphone, or tablet computing device in accordance with the embodiments;

FIG. 7A depicts a tablet computing device and a hand-held smartphone each having a circuitry integrated therein as described in accordance with the embodiments;

FIG. 7B is a block diagram of an embodiment of tablet computing device, a smart phone, or other mobile device in which touchscreen interface connectors are used;

FIG. 8 illustrates a diagrammatic representation of a machine in the exemplary form of a computer system, in accordance with one embodiment;

FIG. 9A depicts a cloud service interacting with a mobile computing device, in accordance with one embodiment;

FIG. 9B depicts first responders interacting with a centralized incident commander and a cloud service interacting with a mobile computing device, in accordance with one embodiment;

FIG. 9C depicts first responders interacting amongst themselves as well as with a cloud service through a mobile computing device, in accordance with one embodiment;

FIG. 10 depicts an exemplary architecture in accordance with described embodiments;

FIG. 11A depicts an exemplary icon field of a cloud service interface in accordance with described embodiments;

FIG. 11B depicts an exemplary cloud service interface of a cloud service provider in accordance with described embodiments;

FIG. 12 depicts first responders interacting amongst themselves as well as with a cloud service via a hub and spoke with wheel scheme, in accordance with described embodiments;

FIG. 13 depicts the primary actives that first responders are involved with according to the described embodiments;

FIG. 14 is a flow diagram illustrating a method in accordance with disclosed embodiments; and

FIG. 15 shows a diagrammatic representation of a computing device (e.g., a “system”) in which embodiments may operate, be installed, integrated, or configured.

### DETAILED DESCRIPTION

Described herein are methods and systems for implementing an accident scene rescue, extrication, and incident safety solution. In one embodiment, such means include receiving vehicle identification information; querying a database based at least in part on the received vehicle identification information to determine a vehicle type; retrieving associated data based on the determined vehicle type; and presenting the associated data to a user interface and causing the user interface to display at least the determined vehicle type, a navigation menu, and at least a sub-set of the associated data retrieved based on the determined vehicle type.

In accordance with related embodiments there is further describe a system having at least a processor and a memory therein, in which the system includes means for establishing a first communications link between a first client device and the system over a network, the first client device being associated with a first emergency response person; means for displaying an interface at the first client device from the system; means for identifying an emergency response incident type at the first client device via the interface; means for generating an incident response record at the system responsive to the identifying of the emergency response incident type at the first client device; means for establishing a second communications link between a second client device and the system over the network, the second client device being associated with a second emergency response person; means for displaying the interface at the second client device from the system; means for displaying emergency response information at the interface of the second client device selected based on the emergency response incident type identified at the first client device, in which the emergency response information is communicated from the system to the second client device over the network; and means for receiving incident metrics at the system captured via the interface at the second client device and recording the incident metrics within the incident response record.

In the following description, numerous specific details are set forth such as examples of specific systems, languages, components, etc., in order to provide a thorough understanding of the various embodiments. It will be apparent, however, to one skilled in the art that these specific details need not be employed to practice the embodiments disclosed herein. In other instances, well known materials or methods have not been described in detail in order to avoid unnecessarily obscuring the disclosed embodiments.

In addition to various hardware components depicted in the figures and described herein, embodiments further include various operations which are described below. The operations described in accordance with such embodiments may be performed by hardware components or may be embodied in machine-executable instructions, which may be used to cause a general-purpose or special-purpose processor programmed with the instructions to perform the operations. Alternatively, the operations may be performed by a combination of hardware and software.

Embodiments also relate to an apparatus for performing the operations disclosed herein. This apparatus may be specially constructed for the required purposes, or it may be a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description below. In addition, embodiments are not described with reference to any particular programming language. It will be appreciated that a variety of programming languages may be used to implement the teachings of the embodiments as described herein.

Embodiments may be provided as a computer program product, or software, that may include a non-transitory machine-readable medium having instructions stored thereon, which may be used to program a computer system (or other electronic devices) to perform a process according to the disclosed embodiments. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical), etc.

Any of the disclosed embodiments may be used alone or together with one another in any combination. Although various embodiments may have been partially motivated by deficiencies with conventional techniques and approaches, some of which are described or alluded to within the specification, the embodiments need not necessarily address or solve any of these deficiencies, but rather, may address only some of the deficiencies, address none of the deficiencies, or be directed toward different deficiencies and problems where are not directly discussed.

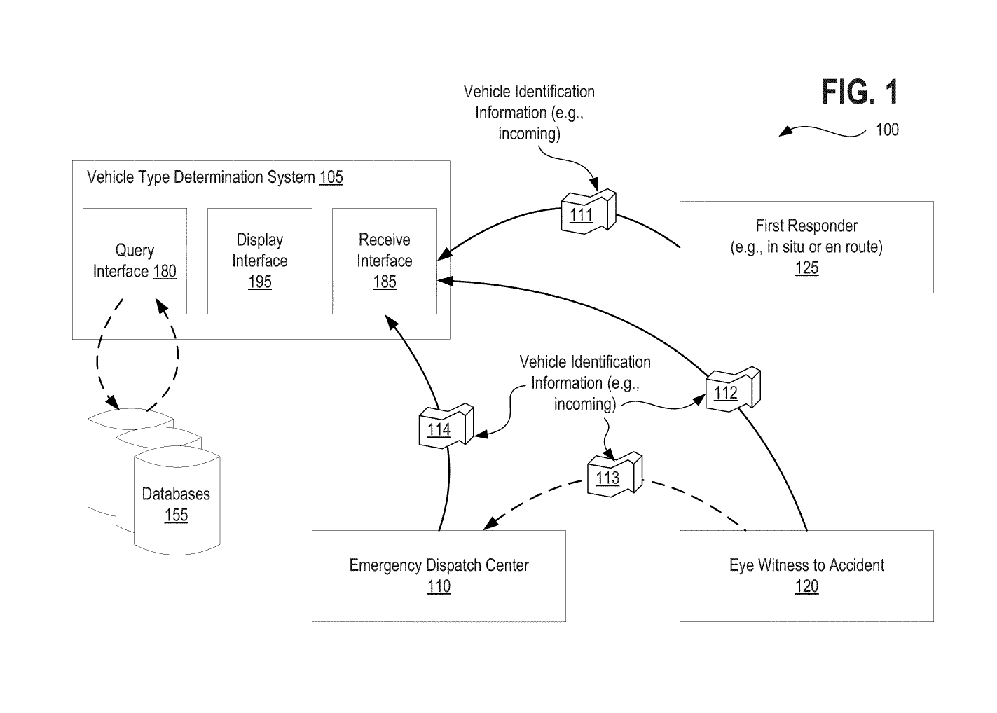

FIG. 1 depicts an exemplary architecture 100 in accordance with described embodiments. In particular, there is depicted a vehicle type determination system 105 which is communicatively interfaced with databases 155 via query interface 180. The vehicle determination system additionally includes a display interface 195 for presenting a user interface or a GUI to a user device and a receive interface 185 to receive vehicle identification information from any of a number of varying sources.

For instance, as depicted here, there is an eye witness to an accident 120 capable to observe, record, witness, or otherwise collect vehicle identification information 112 which may then be passed to the receive interface 185 directly, such as via radio or telephone to a person with an available device, such as a police officer or by entering the data at an available device, such as a police officer or paramedic arriving on scene before first responders capable of vehicle extrication, but nevertheless having access to a user interface within which to enter the observed vehicle identification information. Alternatively, an eye witness to an accident 120 may pass vehicle identification information 113 to an emergency dispatch center 110 which then in turn enters the vehicle identification information 113 into an appropriate user interface, for instance, at an emergency dispatch terminal, and then passes the vehicle identification information 114 to the receive interface 185 of the vehicle type determination system 105. In another embodiment, a first responder 125 either en route (e.g., receiving non-entered vehicle identification information through dispatch) or in situ observing a wrecked vehicle may observe and enter vehicle identification information 111 into an appropriate user interface which is then passed to the receive interface 185 of the vehicle type determination system 105.

Problematically, conventional solutions simply fail to provide adequate information about vehicles which becomes a serious problem for first responders arriving on scene and having to address the myriad of differing kinds of safety devices which may pose a serious risk of injury or death during a passenger's extrication from a wrecked vehicle.

Moreover, the kind of information for a vehicle that is available to the public utilizes a different taxonomy, nomenclature, and organizational method than what is utilized by the vehicle manufacturers themselves. This difference causes further problems in identifying a particular vehicle type so as to retrieve and assess appropriate accident scene rescue, extrication, and incident safety solutions. Consider for example that manufacturer BMW sells a “Series 3” and a “Series 5” vehicle, but internally, BMW identifies these vehicles as sometimes “e42” or “e43,” which causes the identification of a vehicle type to be complicated as first responders are not familiar with these internal manufacturing codes, yet, many manufacturers arrange their rescue and extrication guidelines by these internal codes rather than more widely understood nomenclature utilized in the public space. Other kinds of information are known to mechanics and may yet be organized by different vehicle type codes than the public nomenclature or the vehicle manufacture's codes. Regardless, it is important to be able to retrieve such information, for instance, illustrating how to shut off a fuel line or how to disconnect a hybrid vehicle's high voltage battery. Because of the varying vehicle taxonomies, first responders may not be able to retrieve the needed information simply by a vehicle's badge, such as BMW Series 3, or Honda Accord, etc.

Still further, it will readily be appreciated that a badly wrecked automobile simply does not look the same as in its pre-accident condition. Vehicles can be badly smashed, distorted, and even torn apart during a violent accident which further complicates appropriate determination of a vehicle type.

Some helpful information is available to fire fighters and other first responders according to Vehicle Identification Numbers (VINs), but VINs are problematic because they utilize a 17 character alphanumeric sequence which is very often hidden in obscure places on a vehicle, which in turn causes problems of incorrect reading, transcription, and entry of a vehicle's VIN and also the problem of even seeing a VIN on a wrecked vehicle. For instance, VINs are conventionally provided at the base of a windshield, but may be hidden from view by a smashed windshield or may have been physically obscured from view due to the damage and physical compression or movement of a vehicle's structure during an accident. Other vehicle manufactures are now promoting the use of QR codes, however, such codes are on very few vehicles and will not likely be retrofitted onto the millions of vehicles already on the public roads today.

The dangers of accident scene rescue, extrication, and incident safety solutions cannot be understated. Different vehicles have hazards in different places and the risk is non-trivial. For instance, a seatbelt tensioner is very dangerous to both passenger and rescuer alike in a post accident condition, as is a gas generator for an airbag which may trigger and explode and injure or the passenger or the rescuer. Similarly, new electric systems of high voltage hybrid vehicles are dangerous if the wrong wire is cut at the wrong time, potentially causing electrocution. Further still, these hazard conditions are not standardized and may thus be located in different places for different cars, even in different places for vehicles from the same vehicle manufacturer. Counter intuitively, as automobiles have gotten safer for the unexpected accident condition, they have simultaneously become more dangerous in the post accident environment, in which the airbags may explode, seatbelt tensioners may retract the seatbelt violently, and high voltage lines that provide green energy for the vehicle can lethally electrocute an unwitting passenger or rescuer.

Other hazards are present which can inhibit expeditious and safe extrication of a passenger, such as high tension steel pillars which provide excellent passenger safety during an accident but also are highly resistant to even industrialized cutting and extrication means, and thus, must be avoided for safe passenger extrication. However, first responders cannot simply differentiate between regular steel and high tension steel by looking at it. Failure to understand a non-cut point for vehicle extrication may waste time and place injured victims at risk.

Non-intuitive risks are present as well, such as bumper and hood shocks which may explode violently when heated, such as by a vehicle gasoline fire or even become dangerous projectiles when they burst. Fuel pumps provide yet another risk for a damaged vehicle as they may not be shut off predictably and may quite literally fuel a fire or a fire risk.

It is not practical for first responders to memorize every possible permutation of vehicle hazards, and thus, improved information retrieval means such as those described herein can better facilitate their efforts in conducting safer and more expeditious accident scene rescue, extrication, and incident safety solutions.

The query interface 180 of the vehicle type determination system 105 enables search by any of a variety of methods, with appropriate user interfaces being presented at a compatible device via the display interface 195. For instance, it is possible to search for the appropriate vehicle type by license plate number which may or may not additionally include licensing authority information, such as a state, country, province, etc., or search may be conducted by a VIN number, or search may be conducted using free text, wild-carding (e.g., a portion but not all of a VIN or license plate, or missing licensing authority data, etc.), or search may be conducted through a gallery style search, such as selecting fuel type and trim level, or vehicle make and model, or vehicle style (e.g., coupe, van, etc.) and doors, and then corresponding images, etc. Regardless, the vehicle identification information received from the varying sources described enable the query interface to search for and identify the appropriate vehicle type. Using the identified or determined vehicle type, additional associated information may then be retrieved for presentment to a user via the display interface 195 to aid in the accident scene rescue, extrication, and incident safety solution.

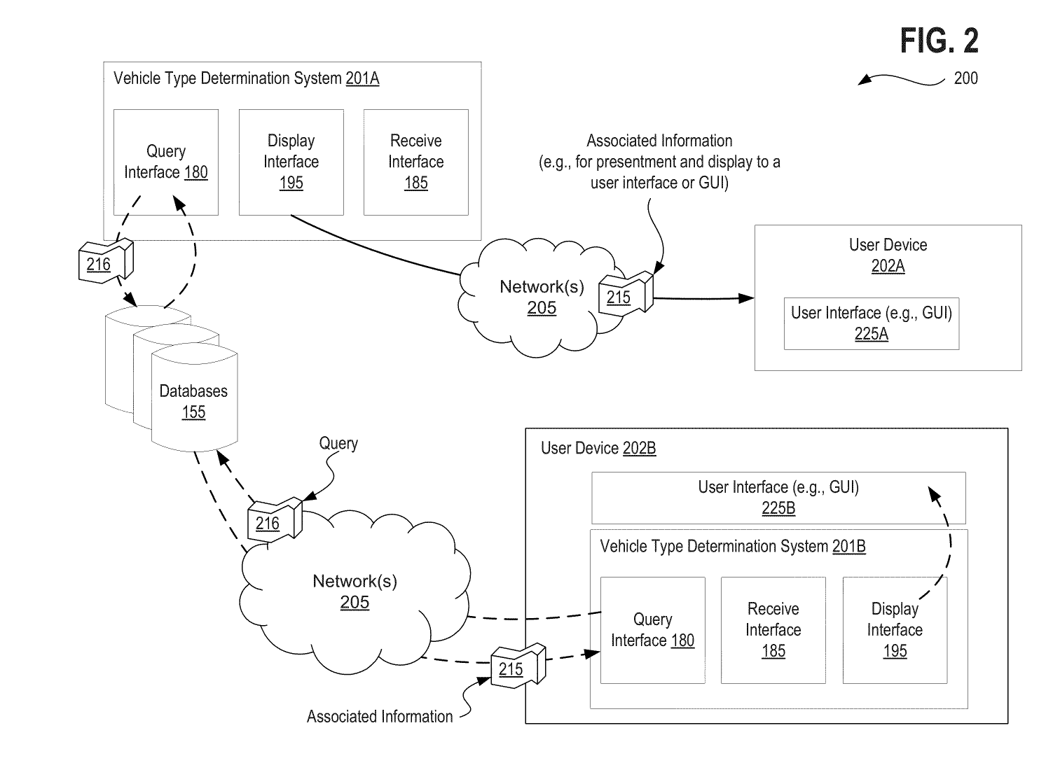

FIG. 2 depicts an alternative exemplary architecture 200 in accordance with described embodiments. The databases 155 are again depicted here, however, the vehicle type determination system is now depicted in varying forms and embodiments. On the upper left is a vehicle type determination system 201A which includes therein a query interface 180 capable of querying (e.g., via query 216) databases 155 either remotely or locally, over a network (e.g., a LAN, VPN, Internet, WAN, etc.). Further depicted is the receive interface 185 and a display interface. Shown here is display interface 195 of vehicle type determination system 201A sending associated information 215 (e.g., additional information for presentment and display at a user interface or GUI) to a user device 202A via network(s) 205. Such additional information may then be displayed or presented at user interface 225A of user device 202A. As depicted, user device 202A may operate remotely from the vehicle type determination system 201A which may reside as an application at a hosted computing environment, such as a SaaS (Software as a Service) implementation which provides cloud computing services or software on-demand without requiring the user device 202A to execute the application locally, instead simply accessing the resources of the vehicle type determination system 201A remotely and rendering locally the information for display at the user interface 225A.

Alternatively, as depicted on the bottom portion is user device 202B having embodied therein vehicle type determination system 201B which again includes query interface 180, receive interface 185, and display interface 195. Query interface 180 of user device 202B is capable of querying (e.g., via query 216) the databases 155 which are depicted as residing remotely from the user device 202B. The databases 155 again return the associated information 215 to the query interface of user device 202B. The associated information 215 returned may then be presented or caused to be displayed by the display interface 195 to the user interface 225B (e.g., GUI) of the user device 202B. Unlike user device 202A, the user device 202B may execute an application locally capable of carrying out the methodologies described and access database resources remotely. Other combinations are also feasible, such as having some data stores and database resources (e.g., such as a VIN to vehicle type mapping database) residing locally at the vehicle type determination system 201A or 201B and other databases (e.g., such as a license plate look up system) reside remotely and simply be made accessible via a network 205 as depicted.

The associated information 215 returned provides not merely extrication information but may provide a wide range of information correlated to and retrievable with the determined vehicle type as identified pursuant to the various search methodologies described. For instance, associated information 215 may describe how the vehicle components work, describe repair information, or may provide a large group of structured information which is then provided through a filterable view so that the most desirable information to a given user may be selected and viewed at the user interface 225A-B.

Take for example a fire fighter in the role of a first responder utilizing the user interface 225A-B. After opening and authenticating through the user interface 225A-B, if appropriate, the user may be presented with a search context at the user interface 225A-B, through which the user may enter license plate and state information, or other licensing authority, and submit the search, responsive to which the receive information would accept the input, query a first database to correlate the license plate information to a VIN number or a VIN number range, return the VIN or VIN range, and then the query interface 180 would query a second database using the VIN number information for a vehicle type. Once the vehicle type is determined, a third database, or additional databases and data stores may then be queried to retrieved the associated information 215 for display to the user via the user interface 225A-B via the display interface 195 means of the vehicle type determination systems 201A-B depicted.

The license plate search capability may take the form of a text entry having a corresponding and restricted data mask, or may be a free form text entry which permits wild-carding and potentially errors to be handled by the vehicle type determination system 201A-B or may constitute an image capture device, such as a smart phone or tablet capable of taking a picture of a physical license plate, extracting the license plate's alphanumeric string and licensing authority, and then applying the abstracted data from the picture or license plate image to the search interface to proceed as above just as if text had been entered.

If the license plate search fails, then an alternative but less preferred means is to search by VIN, however, first responders are far less likely to have access to a correct VIN number before arriving on scene as eye witnesses, police, ambulance personnel, etc., are very likely to understand the need to provide a license plate number, but far less likely to understand the need or even be capable of correctly ascertaining a 17 digit VIN by which to identify the vehicle. Nevertheless, the search means are provided in the event that a VIN is obtained or the license plate search fails to identify the corresponding vehicle type which relies upon accurate information in the resource databases being transacted with over the networks 205 as described.

Having entered the license plate information or VIN information and performed the search as described, the user interface 225A-B may, by default, display the vehicle type information and a summary of the vehicle with key data for quick reference, along with a navigation menu through which the first responder or other user may then self navigate to the appropriate resources needed for the situation at hand, be it accident scene rescue and extrication, research, training, etc. As alluded to previously, search does not necessarily require VIN or license plate information, but rather, may be conducted via a gallery search with a variety of starting criteria, which build to narrow down upon the appropriate vehicle type determination. For instance, a gallery search may begin with the manufacturer, such as Nissan, Toyota, Ford, etc., which then displays a sub-set gallery selection interface for vehicle types not yet ruled out. For instance, selecting Ford would rule out all manufacture types not corresponding to Ford. Alternatively, gallery search may begin with a year, or a body type (e.g., wagon, coupe, truck, minivan, etc), or a fuel type (e.g., electric, diesel, gas, etc.), or a trim level, or a model type, etc., and is selectable by the user. For example, if the vehicle has a trim level badge such as LX, EXL, or DX, etc., then the search could be conducted accordingly, even without the user knowing the year, make, model, or other typical identification information. Or if the user wishes to select hybrid vehicles, or electric vehicles, then again, a gallery search selection may be instituted accordingly, which will then present an appropriate sub-set for all vehicle model types not yet ruled out.

Alternatively, the user may use free form search or wild-carding. For instance, wild carding may prove helpful where partial but incomplete license plate information is known or a partial but incomplete VIN is known. Free form search may be utilized, where the user simply enters free form text for search, such as “Ford hybrid DX” which would then render the appropriate results for identification and selection by the user. The search may, if necessary, return sub-groups such as vehicle years 1967-1989, 1990-2001, 2002-2011, and 2012-2014, from which the user may then further narrow the vehicle until a determined vehicle type is reached.

Freeform search and gallery search may prove especially useful in training scenarios where the user is researching but would not have actual license plate data or VIN data, as such information would only be available during an accident scene rescue and may not be pertinent for training purposes.

Embodiments that provide default summary information may present an image or likeness of the determined vehicle type along with key features of the vehicle such as break resistant glass, high tension steel pillars and locations, fuel types, battery type and chemistry, electric voltages and line locations, air bags, second row and passenger air bags, and so forth.

Associated information 215 retrieved and displayed may include more than merely the determined vehicle type, navigation menu, and summary information according to the various embodiments. For instance, though not necessarily displayed immediately, associated information 215 may include much more detailed information about vehicle features.

Searching by license plate may provide a preference in geographical context, to identify first the most probable vehicles in a given state, region, country, etc., so as to improve data results. Results may then be complementary or contradictory from which probability may be applied or multiple options may be presented to the user for selection and verification. License plate searching may be provided through a third party service provider and conducted through an Internet based web API through which queries are submitted and results are returned. The results returned may be a VIN number specific to the corresponding vehicle through which subsequent query utilizing the specific VIN can then be used to map or correlate the VIN number to the appropriate vehicle type determination or the license plate search may return a VIN number range. For instance, rather than having every feasible VIN number for every known vehicle, it may be that the license plate query interface provider returns a range of VINs within which the license plate resides. In such a case, it may be that a second database which correlates VIN numbers to vehicle type determination requires the specification of a particular VIN and not a VIN number range, in which case, a synthesized VIN is rendered based on the range, in which the synthesized VIN is compatible with the appropriate VIN number format and complies with a VIN that could be within the range, subsequent to which the synthesized VIN is then submitted as a query to an appropriate database to map or return the vehicle type determination. For example, a synthesized VIN that is compatible with a VIN mask may take the form of the portions of the VIN that are known and unique based on the VIN range that is returned and then randomly selecting, or taking the average, or the median, or the first or the last number sequence or alphanumeric sequence which conforms to the appropriate VIN data mask as well as falls within the VIN range returned and as such, represents a plausible VIN from the returned VIN range even if the VIN does not necessarily correlate (and most probably will not correlate) to the unique vehicle in question for which the license plate data is known. Because the determined vehicle type is being sought and not a unique vehicle identification, it is acceptable to synthesize the VIN in such a way for further database queries, whereas such means would likely not be acceptable in other contexts, such as for an insurance company attempting to underwrite coverage on a specific vehicle.

With the determined vehicle type, yet another database 155 or data store may be referenced, or multiple such resources may be utilized. For instance, a database of mechanics' repair information may be accessed based on vehicle type or a correlated vehicle ID for that particular database, from which information returned may include, for instance, how to change a door handle to how to disconnect a fuel line or a high voltage battery. Some of the information may thus be relevant whereas other information is not. The information may then be presented in differing views, such as a curated view in which the deemed relevant information is presented first or a filterable view in which all information is presented and the user is enabled to sift or filter through the data to identify the appropriate resource or information within a larger mixed data set. For instance, other data returned from such a database may be recall notices, engine codes, repair time allotments, service procedures, part codes, schematics, vehicle photographs, etc. The filterable view may thus present the information without bias, whereas the curated view provides with priority, or possibly only provides, information about, for example, locks, sealed spaces, fuel lines, high voltage electrics, reinforced door beams, break resistant glass, etc.

Such information is not necessarily provided by so called rescue cards issued from vehicle manufacturers. For instance, it may be that a rescue car illustrates an extrication requiring separation of a door or cutting of high voltage lines in a given sequence, both of which effectively destroy the car and take additional time, whereas service mechanics may know through appropriate databases that disengaging a child's lock or removal of a fuse may provide the desired result for the purposes of extrication as well as service, may also be faster, and will not destroy a vehicle. Consider for example a child locked alone in a car in which case there is no accident or wrecked car, per se, yet extrication is still required. Obviously the child's safety is paramount, however, safe extrication without necessitating the destruction of a vehicle may nevertheless be an appropriate goal where feasible.

Additional information that may be retrievable through such databases are manufacturing codes which may then be utilized as search keys for other databases to obtain still richer data for presentment to the user interface 225A-B.

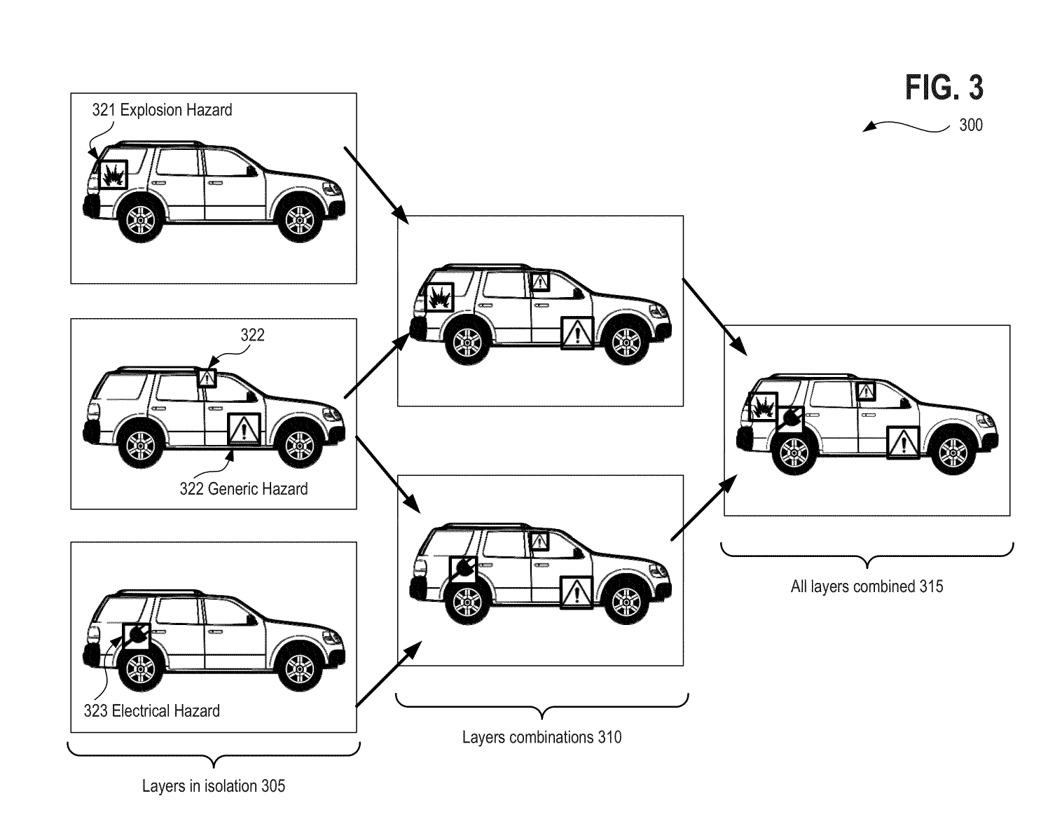

FIG. 3 depicts a series 300 of layered images utilized in conjunction with described embodiments. For instance, depicted here are layers in isolation 305, different layer combinations 310, and all layers combined 315. There may be many more than three distinct layers for any given determined vehicle type, however, the three isolated layers, foils, or laminars that are depicted here are merely exemplary. As can be seen on the left, the top one of the layers in isolation 305 depicts a fire or explosion hazard 321, such as a fuel tank or trunk shocks. The next layer down depicts a generic hazard 322, perhaps a high tension steel door pillar or an airbag. The next layer down on the bottom of the three layers in isolation 305 depicts an electrical hazard 323, such as a high voltage line or a high voltage motor located at or near each of the vehicles wheels. Any of a variety of hazards may be depicted in such a way. Moving from left to center, it can be seen that there are different layer combinations 310, in which the top and middle left most layers are combined showing now a single vehicle but with combined hazards including the explosion hazard and the generic hazard. At the bottom of the layers combinations 310 a different combination is provided which results from the left most bottom and left most middle layers being combined to now show an electrics hazard along with the generic hazard. Finally, at the rightmost side, all layers combined 315 are depicted in which the explosion hazard 321, the electrics hazard 323, and the generic hazard 322 are all depicted together within a single foil, layer, or laminar.

According to certain embodiments, the images within the layers may be merely an outline with various internal features and hazards displayed throughout multiple ones of the layers in a series of layers. Each of the layers may be isolated or aggregated by the end user through the navigation and user interface. The types of layers may be similar to the categories provided with vehicle components display context, such as schematics, including depicting a similar vehicle outline, vehicle internal or interior details, seats layer, hazard layer information, electrical, fuel system, etc., each depicted using icons or keys to show factual information about what and where the various hazardous features are located within the determined vehicle type.

The layers may correspond to a rescue card format which is optimized for viewing online and navigating via user events, clicks, presses, swipes, etc., through to the various elements of the determined vehicle type, layer by layer to build up into an aggregate view or to peel back the particular elements that the user wishes to view or hide.

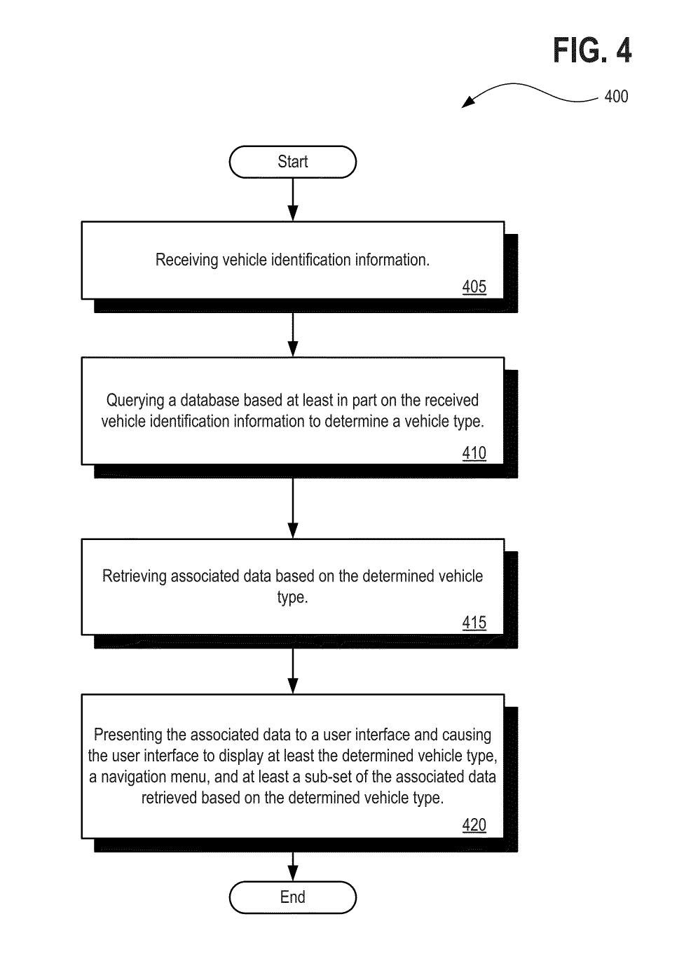

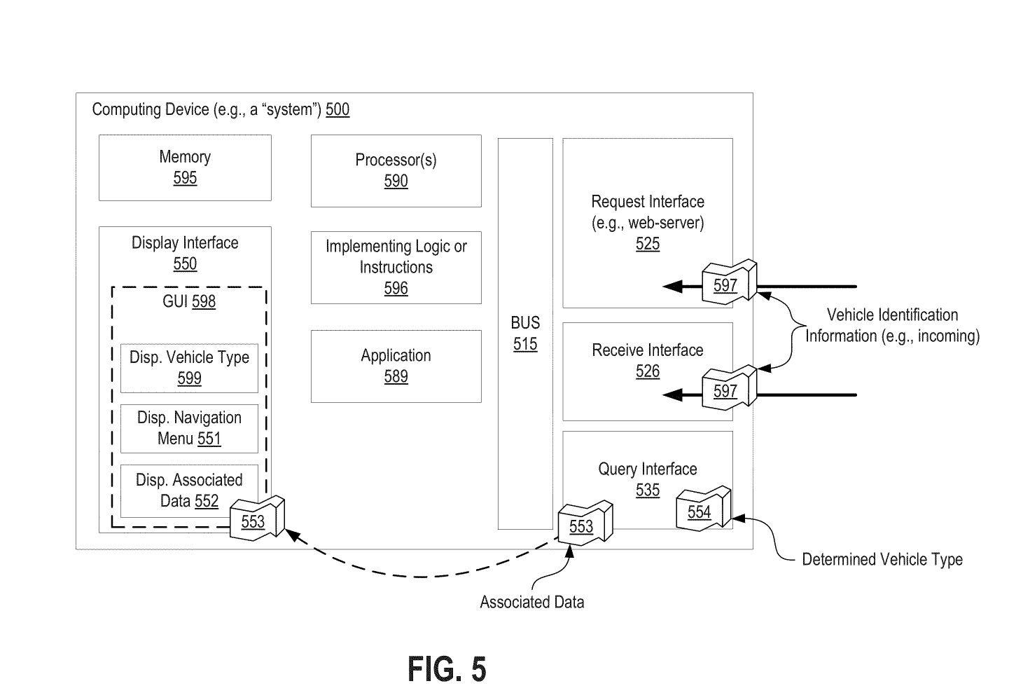

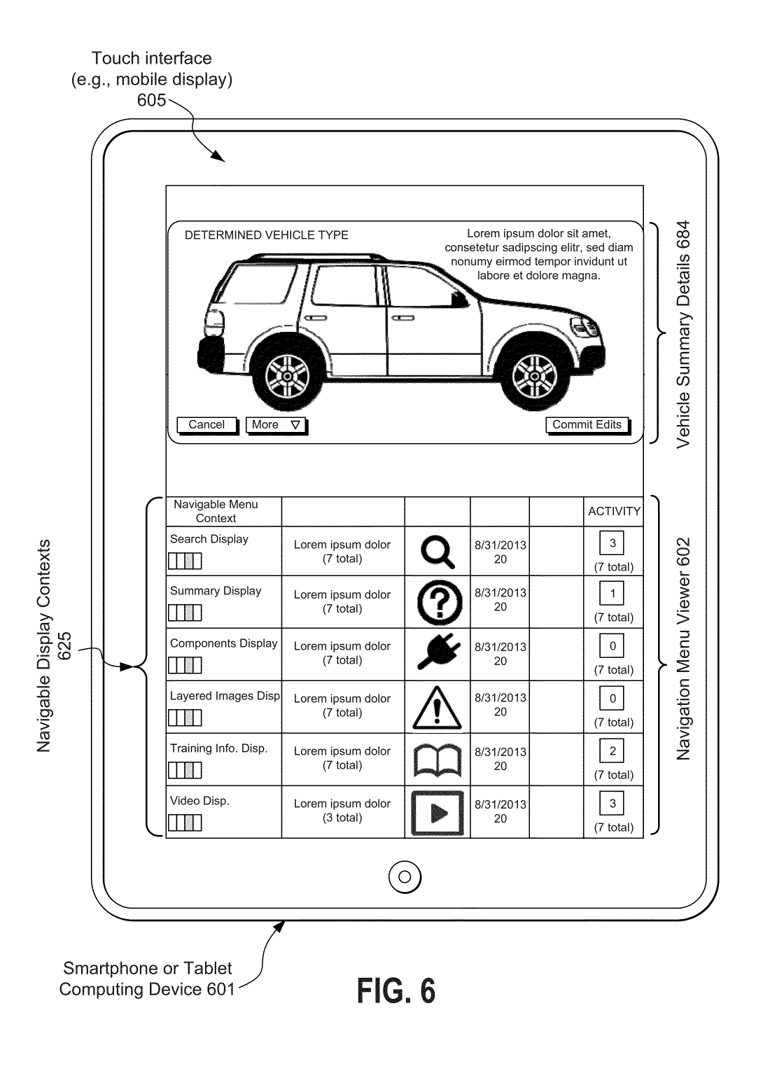

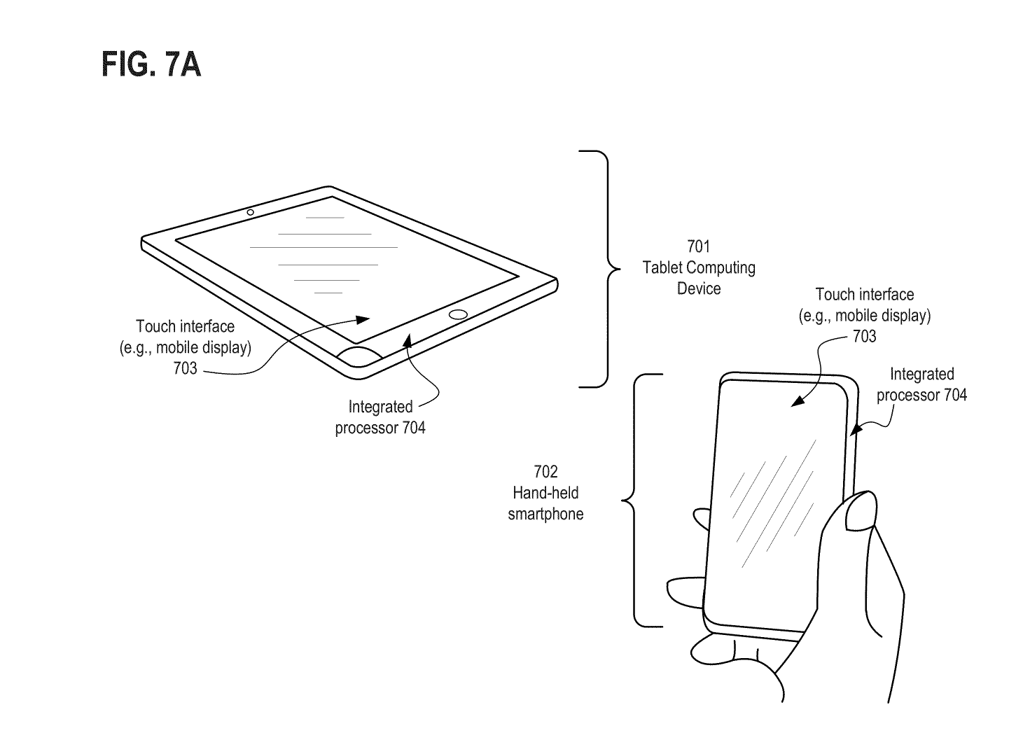

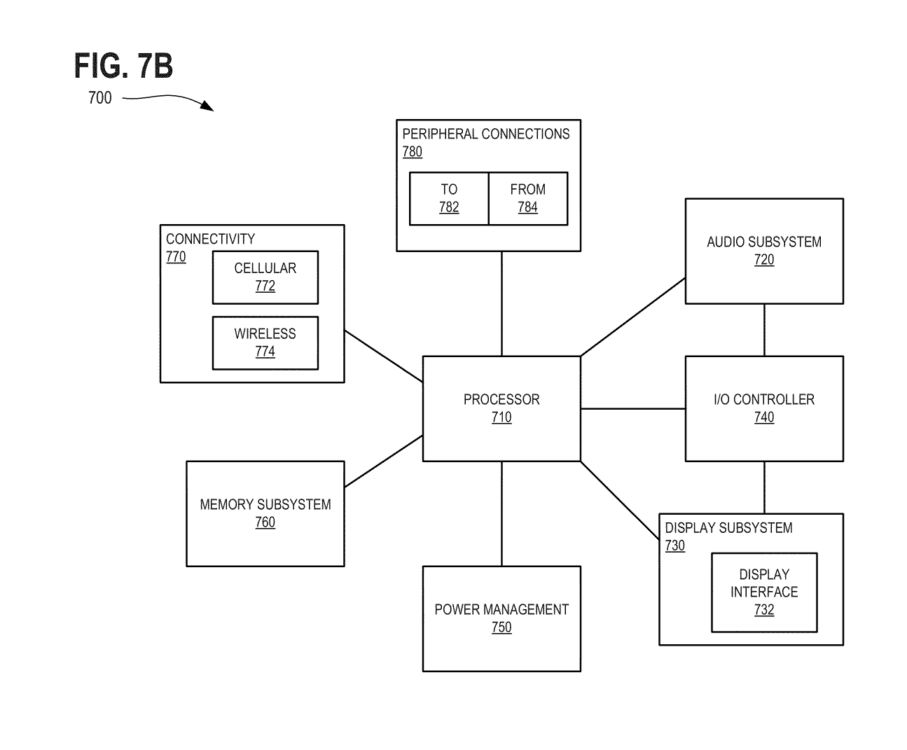

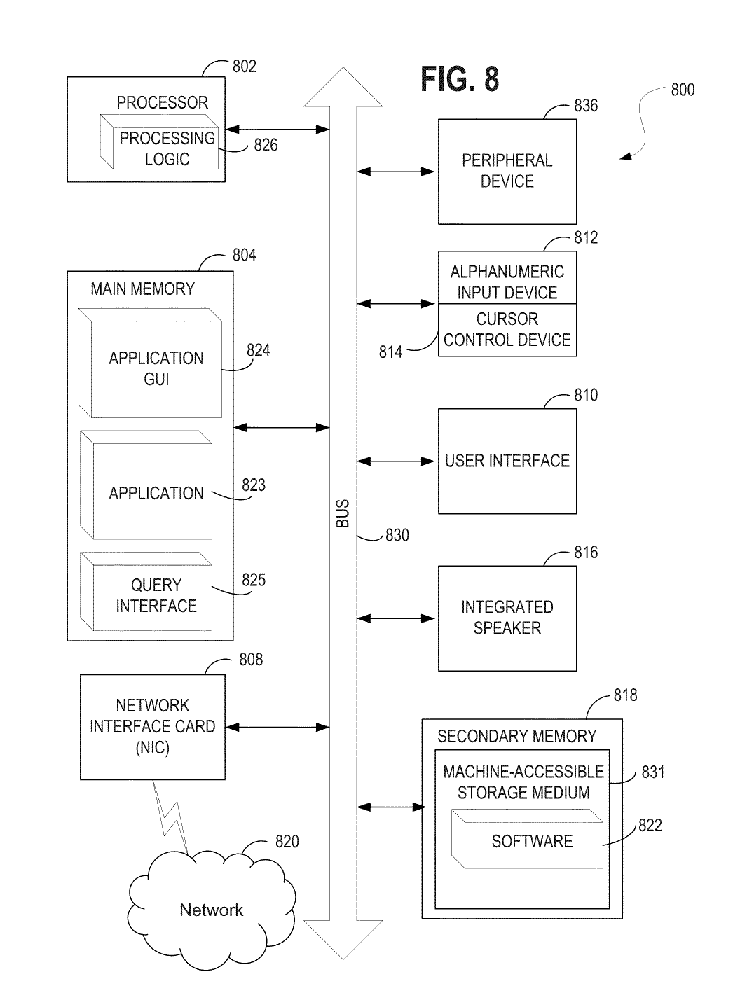

FIG. 4 is a flow diagram illustrating a method 400 for implementing an accident scene rescue, extrication, and incident safety solution in accordance with disclosed embodiments. Method 400 may be performed by processing logic that may include hardware (e.g., circuitry, dedicated logic, programmable logic, microcode, etc.), software (e.g., instructions run on a processing device to perform various operations such as receiving, querying, retrieving, record retrieval, presenting, displaying, determining, analyzing, processing transactions, executing, providing, linking, mapping, communicating, updating, transmitting, sending, returning, etc., in pursuance of the systems, apparatuses, and methods, as described herein. For example, the vehicle type determination system 105 as depicted at FIG. 1, the computing device (e.g., a “system”) 500 as depicted at FIG. 5, the smartphone or tablet computing device 601 at FIG. 6, the hand-held smartphone 702 or mobile tablet computing device 701 depicted at FIG. 7A, or the machine 800 as depicted at FIG. 8, may implement the described methodologies. Some of the blocks and/or operations listed below are optional in accordance with certain embodiments. The numbering of the blocks presented is for the sake of clarity and is not intended to prescribe an order of operations in which the various blocks must occur.

At block 405, processing logic receives vehicle identification information.

At block 410, processing logic queries a database based at least in part on the received vehicle identification information to determine a vehicle type.

At block 415, processing logic retrieves associated data based on the determined vehicle type.

At block 420, processing logic presents the associated data to a user interface and causing the user interface to display at least the determined vehicle type, a navigation menu, and at least a sub-set of the associated data retrieved based on the determined vehicle type.

According to another embodiment of method 400, receiving the vehicle identification information includes one of: receiving the vehicle identification information from a police, fire, and/or emergency dispatch center (“dispatch”), in which the dispatch receives the vehicle identification information via radio or telephone and enters the vehicle identification information into a dispatch computer terminal for transmission to the system, the system receiving the vehicle information from the dispatch computer terminal; receiving the vehicle identification information via a first responder's in situ computing device en route to an accident scene; receiving the vehicle identification information via a mobile computing device, tablet, smart phone, or laptop computer having the user interface displayed thereupon, in which the mobile computing device, tablet, smart phone, or laptop computer receives the vehicle identification information as a user input and transmits the vehicle identification information to the system for use in querying the database; and receiving the vehicle identification information from a first computing device, communicating the vehicle identification information to the system over a network, and communicating the associated data for presentment to the user interface to a third computing device over the network.

According to another embodiment of method 400, receiving the vehicle identification information includes receiving license plate and licensing authority data as the vehicle identification information; in which the method further includes querying a second database, distinct from the first database, in which querying the second database includes specifying the license plate and licensing authority data as part of a search query to the second database and receiving a Vehicle Identification Number (VIN) or a VIN range responsive to the querying of the second database; and in which querying the first database based at least in part on the received vehicle identification information to determine a vehicle type includes querying the first database based at least in part on the received VIN or the VIN range received from the second database.

According to another embodiment of method 400, the second database includes a third party database operating as a cloud based service and accessible to the system over a public Internet network; in which the first database includes a locally connected database accessible to the system via a Local Area Network; in which receiving the vehicle identification information includes receiving an alphanumeric string corresponding to an automobile license plate and licensing authority; in which querying the second database includes querying the third party database operating as the cloud based service via an Application Programming Interface (API) into which the alphanumeric string corresponding to the automobile license plate and licensing authority is entered as input; in which querying the database based at least in part on the received vehicle identification information includes specifying the alphanumeric string corresponding to the automobile license plate and licensing authority as an input into the API and receiving the VIN or VIN range in return; and in which querying the first database includes querying the locally connected database specifying the VIN or a VIN compatible string derived from the VIN or VIN range to determine the vehicle type.

According to another embodiment of method 400, querying the first database based at least in part on the received VIN or the VIN range received from the second database includes: querying the second database specifying the received VIN when the VIN is received and querying the second database specifying a synthesized VIN when the VIN range is received; receiving the vehicle type responsive to querying the second database; and in which the synthesized VIN includes an individual VIN compatible string derived from the VIN range, in which the VIN range corresponds to a plurality of theoretical individual VINs and is incompatible with a standardized VIN format.

According to another embodiment the method 400 further includes: querying a third database, distinct from the first and second databases; in which querying the third database includes specifying the determined vehicle type; and receiving the associated data from the third database responsive to querying the third database.

According to another embodiment of method 400, receiving the vehicle identification information includes one of: receiving a Vehicle Identification Number (VIN); receiving an alphanumeric string corresponding to a vehicle license plate string and associated state, province, or country having licensing authority for the license plate string; receiving an image of the vehicle license plate and extracting the alphanumeric string corresponding to the vehicle license plate from the image; receiving a partial vehicle license plate and wildcarding a missing portion of the partial vehicle license plate; receiving a search string having therein free form text or key word search text; and receiving user input at the user interface specifying the vehicle identification information from a graphical gallery view of available vehicle types.

According to another embodiment of method 400, the determined vehicle type includes a unique vehicle identifier (vehicle ID), the unique vehicle ID corresponding to at least a year, make, and model, and optionally specifying one or more of manufacturer vehicle code, chassis code, fuel type, trim level, engine type, and drive train.

According to another embodiment of method 400, retrieving the associated includes receiving, based on the determined vehicle type, one or more of: vehicle rescue cards; vehicle Frequently Asked Questions (FAQs); vehicle foils, layers, and/or laminar images, each depicting vehicle components; vehicle hazard layers; vehicle video demonstrations; vehicle rescue training information; vehicle safety data; vehicle telemetry data; vehicle web forum data; vehicle schematics; vehicle parts lists; vehicle photographs; vehicle diagrams; vehicle cut points and non-cut points for emergency passenger extrication from a wrecked vehicle; and vehicle de-electrification instructions for a hybrid electric vehicle and non-cut points specific to the hybrid electric vehicle.

According to another embodiment of method 400, presenting the associated data to a user interface includes presenting the associated data to a Graphical User Interface (GUI) at a client device communicably interfaced to the system, in which presenting to the GUI includes presenting a graphical navigational menu at the GUI of the client device and presenting a summary based on the determined vehicle type to the GUI, the summary having been retrieved as the sub-portion of the associated data retrieved.

According to another embodiment of method 400, presenting the associated data to a user interface includes presenting a summary of vehicle key rescue details based on the associated data retrieved, the summary of vehicle key rescue details including on a single screen of the user interface a one or more of: engine type, quantity of airbags, types of airbags, locations of airbags, fuel shut off device location, fuel capacity, break resistant glass locations, quantity of batteries and battery types, battery voltages, battery chemistry, quantity of restraints and restraint types, and cut resistant door beams and locations.

According to another embodiment the method 400 further includes: receiving user input at the GUI responsive to a user initiated event at the graphical navigational menu and responsively navigating the GUI to a new graphical context based on the user input, and presenting at the GUI a different sub-portion of the associated data retrieved based on the new graphical context navigated to based on the user input.

According to another embodiment of method 400, the navigation menu includes a graphical navigational menu displayed within a Graphical User Interface, the graphical navigational menu having navigational elements including at least two or more of: a search context; a summary context; a components context; a layered images context; a Frequently Asked Question(s) context; a service and safety precautions context; a video context; a training context; a community context; and an accident information context.

According to another embodiment of method 400, the search context provides a search interface through which to input any of a license plate, a VIN, a free form text or search parameter inquiry, or gallery input search; in which the summary context provides summary information as a default single screen at a Graphical User Interface (GUI) responsive to a successful search result input to the search context; in which the components context provides additional detailed information about the determined vehicle type in a filterable view; in which the layered images context provides images and diagrams of the determined vehicle type including internal features and hazard features on a plurality of distinct image layers; in which the Frequently Asked Question(s) context provides instructions for specific safety and hazard features of the determined vehicle type; in which the service and safety precautions context provides service bulletin and/or service safety precaution information for mechanics and vehicle repair persons; in which the video context provides previously recorded video and demonstrations of rescue or training based on the determined vehicle type; in which the training context provides links to long form training documentation; in which the community context provides access to internet community forums for rescue personnel filtered based on the determined vehicle type; and in which the accident information context provides data and telemetry information captured from a specific vehicle's Engine Control Module (ECM) or Engine Control Unit (ECU) including at least one or more of vehicle direction, vehicle speed, vehicle airbag deployment(s), vehicle restraint status(es), and vehicle sensor data.

According to another embodiment of method 400, the layered images context provides images and diagrams of the determined vehicle type that display to the user interface an outline representation of the determined vehicle type and location and type of hazard features for the determined vehicle type as a series of layered images, each of the layered images being displayable in isolation responsive to user selection and displayable in an aggregate form with one or more additional ones of the layered images responsive to the user selection at the user interface.

According to another embodiment of method 400, the location and type of hazard features are depicted via the series of layered images, each of the layered images having at least one but not all of the hazard features depicted, the layered images each depicting at least one of: a vehicle outline layer, a vehicle interior details layer, a vehicle seats layer, a vehicle electrical hazard(s) layer, a vehicle restraint hazard(s) layer, a vehicle airbag hazard(s) layer, a vehicle cut-resistant beam hazard(s) layer, and a vehicle fuel system hazard(s) layer.

In accordance with a particular embodiment, there is a non-transitory storage media having instructions stored thereon that, when executed by a processor of a system, the instructions cause the system to perform operations including: receiving vehicle identification information; querying a database based at least in part on the received vehicle identification information to determine a vehicle type; retrieving associated data based on the determined vehicle type; and presenting the associated data to a user interface and causing the user interface to display at least the determined vehicle type, a navigation menu, and at least a sub-set of the associated data retrieved based on the determined vehicle type.

FIG. 5 shows a diagrammatic representation of a computing device (e.g., a “system”) 500 in which embodiments may operate, be installed, integrated, or configured.

In accordance with one embodiment, there is a computing device 500 having at least a processor 590 and a memory 595 therein to execute implementing logic and/or instructions 596. Such a computing device 500 may execute as a stand alone computing device with communication and networking capability to other computing devices, may operate in a peer-to-peer relationship with other systems and computing devices, or may operate as a part of a hosted computing environment, such as an on-demand or cloud computing environment which may, for instance, provide services on a fee or subscription basis.

According to the depicted embodiment, computing device 500 includes a processor or processors 590 and a memory 595 to execute instructions 596 at the computing device 500. The computing device 500 further includes a display interface 550 is to present a Graphical User Interface (GUI) 598; a receive interface 526 to receive vehicle identification information 597 (e.g., as incoming data, etc.); a query interface 535 to query a database based at least in part on the received vehicle identification information 597 to determine a vehicle type 554, in which the query interface 535 is to further retrieve associated data 553 based on the determined vehicle type 554; and in which the display interface 550 to present the associated data 553 to the GUI 598, and in which the display interface 550 is to display at least the determined vehicle type (e.g., displayed vehicle type 599), to display a navigation menu (e.g., displayed navigation menu 551), and display at least a sub-set of the associated data (e.g., displayed associated data 552) retrieved based on the determined vehicle type 554.

According to another embodiment, the receive interface 526 of the computing device 500 receiving the vehicle identification information 597 constitutes one of: the receive interface 526 to receive the vehicle identification information from a police, fire, and/or emergency dispatch center (“dispatch”), in which the dispatch receives the vehicle identification information via radio or telephone and enters the vehicle identification information into a dispatch computer terminal, in which the vehicle identification information is then to be communicated from a first location to the computing device at a second location over a network; or the receive interface 526 to receive the vehicle identification information via a first responder inputs in situ at the display interface of the computing device while en route to an accident scene; or the receive interface 526 to receive the vehicle identification information via a mobile computing device, tablet, smart phone, or laptop computer having the computing device and its display interface embodied therein, wherein the mobile computing device, tablet, smart phone, or laptop computer is to receive the vehicle identification information as a user input to the display interface and transmit the vehicle identification information via the query interface to a remote system over a network for use in querying the database.

According to another embodiment of the computing device 500, each of the components of the GUI 598 provide graphical user elements that may be placed upon a screen or display of a user's device when executing the application 589 or pursuant to execution of the implementing logic or instructions 596.

According to another embodiment, the computing device 500 further includes a web-server to implement a request interface 525 to receive user inputs, selections, incoming vehicle identification information, and other data consumed by the computing device 500 so as to implement the accident scene rescue, extrication, and incident safety solution described herein.

According to another embodiment of the computing device 500, a user interface operates at a user client device remote from the computing device 500 and communicatively interfaces with the computing device 500 via a public Internet; in which the computing device 500 operates at a host organization as a cloud based service provider to the user client device; and in which the cloud based service provider hosts the application and makes the application accessible to authorized users affiliated with the customer organization.

According to another embodiment, the computing device 500 is embodied within one of a tablet computing device or a hand-held smartphone such as those depicted at FIGS. 7A and 7B.

Bus 515 interfaces the various components of the computing device 500 amongst each other, with any other peripheral(s) of the computing device 500, and with external components such as external network elements, other machines, client devices, etc., including communicating with such external devices via a network interface over a LAN, WAN, or the public Internet. Query interface 535 provides functionality to pass queries from the request interface (e.g., web-server) 525 into a database system for execution or other data stores as depicted in additional detail at FIGS. 1 and 2.

FIG. 6 depicts an exemplary graphical interface operating at a mobile, smartphone, or tablet computing device in accordance with the embodiments. In particular, there is depicted a smartphone or tablet computing device 601 having embodied therein a touch interface 605, such as a mobile display. Presented or depicted to the mobile display 605 is the navigation menu viewer 602 in which the navigable display contexts 625 are depicted and available to the user for selection or use in navigation. For instance, there are depicted here a variety of navigation contexts including a search display context, a summary display context, a components display context, a layered images display context, a training information display context, and a video display context. Other contexts may be displayed to a user via the display or may be present within the user interface but off screen, and thus, must be scrolled to, etc. Additionally depicted is the vehicle summary details 684 context from which a user may review the determined vehicle type and default summary information for the vehicle. In one embodiment, the vehicle summary details 684 are presented responsive to a successful search or inquiry to establish or determine the vehicle type. The user may then alter the display by selecting any of a variety of navigable contexts.

Other views and display contexts are also provided and accessible via the navigation menu viewer 602. For instance a Frequently Asked Questions (FAQ) context provides processes and means by which to detail with a vehicle feature or hazard of particular interest. For instance, the FAQ context may teach how to disconnect electrical, battery, airbags, and fuel systems, etc.

In another embodiment there is a FAQ and Layers display context which provides additional information with the previously described layers, such as manufacturer, model, year, body type, fuel type, body style, trim level, manufacturer's vehicle or body code, range of years for applicability of the rescue and hazard data, etc., each of which is retrievable via the search methodologies described above and then integrated into the appropriate view.

In another embodiment there is a video display context which provides, for example, captured helmet cam data obtained through actual or training rescues or an interface to upload and submit such helmet cam data. Video demonstrations may additionally be provided through this context as correlated to a determined vehicle type.

In another embodiment there is a training display context which provides, for example, links to long form training documents, which are often 100-200 pages long and thus are not appropriate for emergencies, but the training materials often do exist for rescues and hazard information and so despite its long format, does provide viable information to fire fighters and first responders for training purposes in a non-emergency situation. Some training information is also provided by firefighters themselves or non-manufacture entities, such as first responders associations, and so the training display context additionally provides this relevant information. Thus, the training display context may link to or provide information by manufacturers, municipalities, fire fighter committees, vehicle experts, mechanics, etc. This kind of information is especially helpful for newer electrified vehicle drive systems for which there may be more pertinent fire fighter derived information pertaining to such electric vehicles that is broadly applicable to many vehicles than the myriad of specific information provided by manufacturers of such vehicles.

In another embodiment there is a components display context which provides, for example, an unfiltered view of all data from any accessible resource, resulting in a huge repository of accessible data according to the determined vehicle type that could be used for training Such data may be explored in a non-emergency context and may provide useful to firefighters and other first responders.

In another embodiment there is a community or web forum display context which provides, for example, access to pre-existing or content specific community web forums through the provided user interface (e.g., such as a touch interface 605 of a mobile display). Incorporating access to such community information within the user interface provides fast and convenient access through which a first responder may read posts and comments by others or may post questions for consideration by others. For instance, a firefighter may post a simple solution to a known problem, or collaborate with others to identify an appropriate rescue and extrication solution.

In another embodiment there is an accident information display context which provides, for example, access to telemetry data and any information accessible from a vehicle's Engine Control Module (ECM) or Engine Control Unit (ECU). This information is sometimes provided through an Over The Air (OTA) interface and may thus be retrieved from a third party's database, wherein other instances the information is accessible from the vehicle's On Board Diagnostics (OBD) data port (e.g., including for example, vehicle direction, vehicle speed, vehicle airbag deployment(s), vehicle restraint status(es), and vehicle sensor data).

FIG. 7A depicts a tablet computing device 701 and a hand-held smartphone 702 each having a circuitry integrated therein as described in accordance with the embodiments. As depicted, each of the tablet computing device 701 and the hand-held smartphone 702 include a touch interface 703 (e.g., a touchscreen or touch sensitive display) and an integrated processor 704 in accordance with disclosed embodiments.

For example, in one embodiment, a system embodies a tablet computing device 701 or a hand-held smartphone 702, in which a display unit of the system includes a touchscreen interface 703 for the tablet or the smartphone and further in which memory and an integrated circuit operating as an integrated processor are incorporated into the tablet or smartphone, in which the integrated processor implements one or more of the embodiments described herein. In one embodiment, the integrated circuit described above or the depicted integrated processor of the tablet or smartphone is an integrated silicon processor functioning as a central processing unit (CPU) and/or a Graphics Processing Unit (GPU) for a tablet computing device or a smartphone.

FIG. 7B is a block diagram 700 of an embodiment of tablet computing device, a smart phone, or other mobile device in which touchscreen interface connectors are used. Processor 710 performs the primary processing operations. Audio subsystem 720 represents hardware (e.g., audio hardware and audio circuits) and software (e.g., drivers, codecs) components associated with providing audio functions to the computing device. In one embodiment, a user interacts with the tablet computing device or smart phone by providing audio commands that are received and processed by processor 710.

Display subsystem 730 represents hardware (e.g., display devices) and software (e.g., drivers) components that provide a visual and/or tactile display for a user to interact with the tablet computing device or smart phone. Display subsystem 730 includes display interface 732, which includes the particular screen or hardware device used to provide a display to a user. In one embodiment, display subsystem 730 includes a touchscreen device that provides both output and input to a user.

I/O controller 740 represents hardware devices and software components related to interaction with a user. I/O controller 740 can operate to manage hardware that is part of audio subsystem 720 and/or display subsystem 730. Additionally, I/O controller 740 illustrates a connection point for additional devices that connect to the tablet computing device or smart phone through which a user might interact. In one embodiment, I/O controller 740 manages devices such as accelerometers, cameras, light sensors or other environmental sensors, or other hardware that can be included in the tablet computing device or smart phone. The input can be part of direct user interaction, as well as providing environmental input to the tablet computing device or smart phone.

In one embodiment, the tablet computing device or smart phone includes power management 750 that manages battery power usage, charging of the battery, and features related to power saving operation. Memory subsystem 760 includes memory devices for storing information in the tablet computing device or smart phone. Connectivity 770 includes hardware devices (e.g., wireless and/or wired connectors and communication hardware) and software components (e.g., drivers, protocol stacks) to the tablet computing device or smart phone to communicate with external devices. Cellular connectivity 772 may include, for example, wireless carriers such as GSM (global system for mobile communications), CDMA (code division multiple access), TDM (time division multiplexing), or other cellular service standards). Wireless connectivity 774 may include, for example, activity that is not cellular, such as personal area networks (e.g., Bluetooth), local area networks (e.g., WiFi), and/or wide area networks (e.g., WiMax), or other wireless communication.

Peripheral connections 780 include hardware interfaces and connectors, as well as software components (e.g., drivers, protocol stacks) to make peripheral connections as a peripheral device (“to” 782) to other computing devices, as well as have peripheral devices (“from” 784) connected to the tablet computing device or smart phone, including, for example, a “docking” connector to connect with other computing devices. Peripheral connections 780 include common or standards-based connectors, such as a Universal Serial Bus (USB) connector, DisplayPort including MiniDisplayPort (MDP), High Definition Multimedia Interface (HDMI), Firewire, etc.

FIG. 8 illustrates a diagrammatic representation of a machine 800 in the exemplary form of a computer system, in accordance with one embodiment, within which a set of instructions, for causing the machine/computer system 800 to perform any one or more of the methodologies discussed herein, may be executed. In alternative embodiments, the machine may be connected (e.g., networked) to other machines in a Local Area Network (LAN), an intranet, an extranet, or the public Internet. The machine may operate in the capacity of a server or a client machine in a client-server network environment, as a peer machine in a peer-to-peer (or distributed) network environment, as a server or series of servers within an on-demand service environment. Certain embodiments of the machine may be in the form of a personal computer (PC), a tablet PC, a set-top box (STB), a Personal Digital Assistant (PDA), a cellular telephone, a web appliance, a server, a network router, switch or bridge, computing system, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 800 includes a processor 802, a main memory 804 (e.g., read-only memory (ROM), flash memory, dynamic random access memory (DRAM) such as synchronous DRAM (SDRAM) or Rambus DRAM (RDRAM), etc., static memory such as flash memory, static random access memory (SRAM), volatile but high-data rate RAM, etc.), and a secondary memory 818 (e.g., a persistent storage device including hard disk drives and a persistent database), which communicate with each other via a bus 830. Main memory 804 includes an application GUI 824 to present information to a user as well as receive user inputs. Main memory 804 includes an application GUI 823 to present and display information, such as the determined vehicle type, a summary, a navigation menu, and other relevant data about a determined vehicle; main memory 804 further includes application GUI 823 to execute instructions, receive and process the vehicle identification information, to determine the vehicle type, to retrieve the associated data, and to interact with the application GUI 824 responsive to user inputs, etc.; and main memory 804 still further includes query interface 825 to query databases in accordance with the methodologies described to receive additional information for processing and display. Main memory 804 and its sub-elements are operable in conjunction with processing logic 826 and processor 802 to perform the methodologies discussed herein.

Processor 802 represents one or more general-purpose processing devices such as a microprocessor, central processing unit, or the like. More particularly, the processor 802 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 802 may also be one or more special-purpose processing devices such as an application specific integrated circuit (ASIC), a field programmable gate array (FPGA), a digital signal processor (DSP), network processor, or the like. Processor 802 is configured to execute the processing logic 826 for performing the operations and functionality which is discussed herein.

The computer system 800 may further include a network interface card 808. The computer system 800 also may include a user interface 810 (such as a video display unit, a liquid crystal display (LCD), or a cathode ray tube (CRT)), an alphanumeric input device 812 (e.g., a keyboard), a cursor control device 814 (e.g., a mouse), and a signal generation device 816 (e.g., an integrated speaker). The computer system 800 may further include peripheral device 836 (e.g., wireless or wired communication devices, memory devices, storage devices, audio processing devices, video processing devices, etc.).

The secondary memory 818 may include a non-transitory machine-readable storage medium or a non-transitory computer readable storage medium or a non-transitory machine-accessible storage medium 831 on which is stored one or more sets of instructions (e.g., software 822) embodying any one or more of the methodologies or functions described herein. The software 822 may also reside, completely or at least partially, within the main memory 804 and/or within the processor 802 during execution thereof by the computer system 800, the main memory 804 and the processor 802 also constituting machine-readable storage media. The software 822 may further be transmitted or received over a network 820 via the network interface card 808.

Additionally described by this Continuation In Part application are methods, systems, and related apparatuses for the implementation and utilization of an incident response information management solution for First Responders.

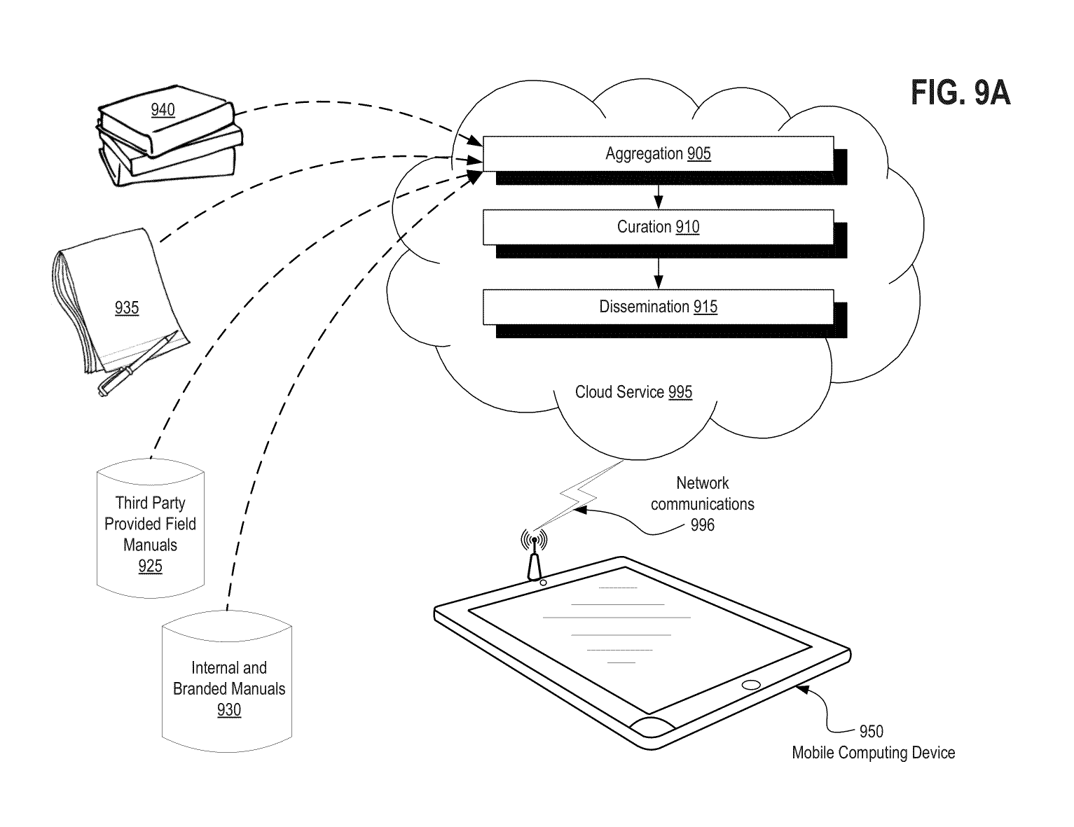

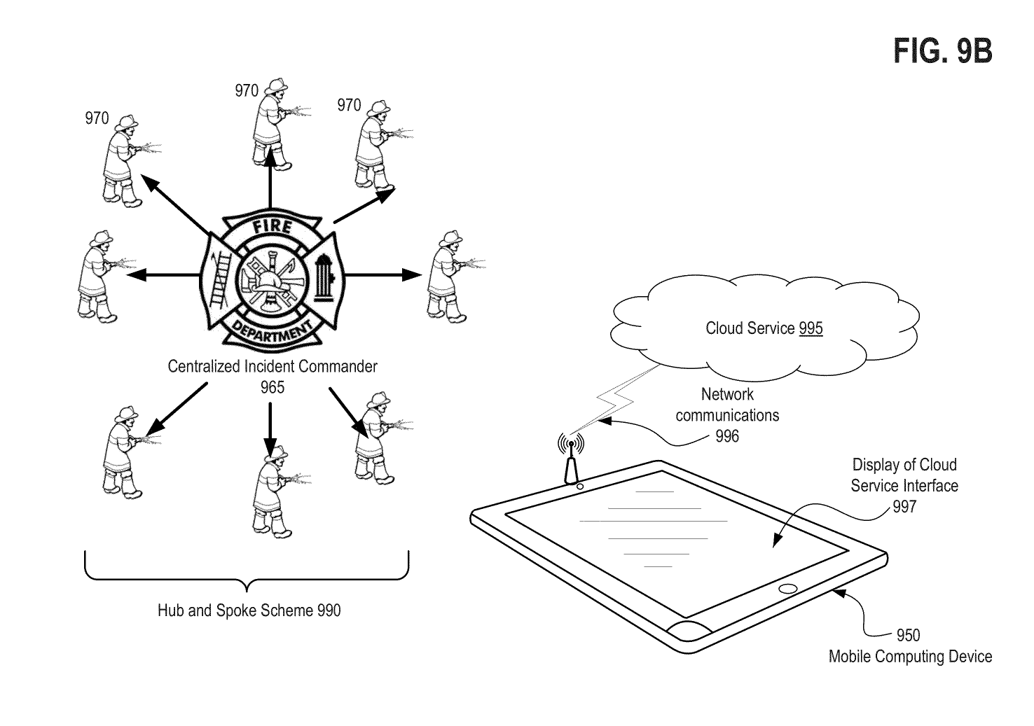

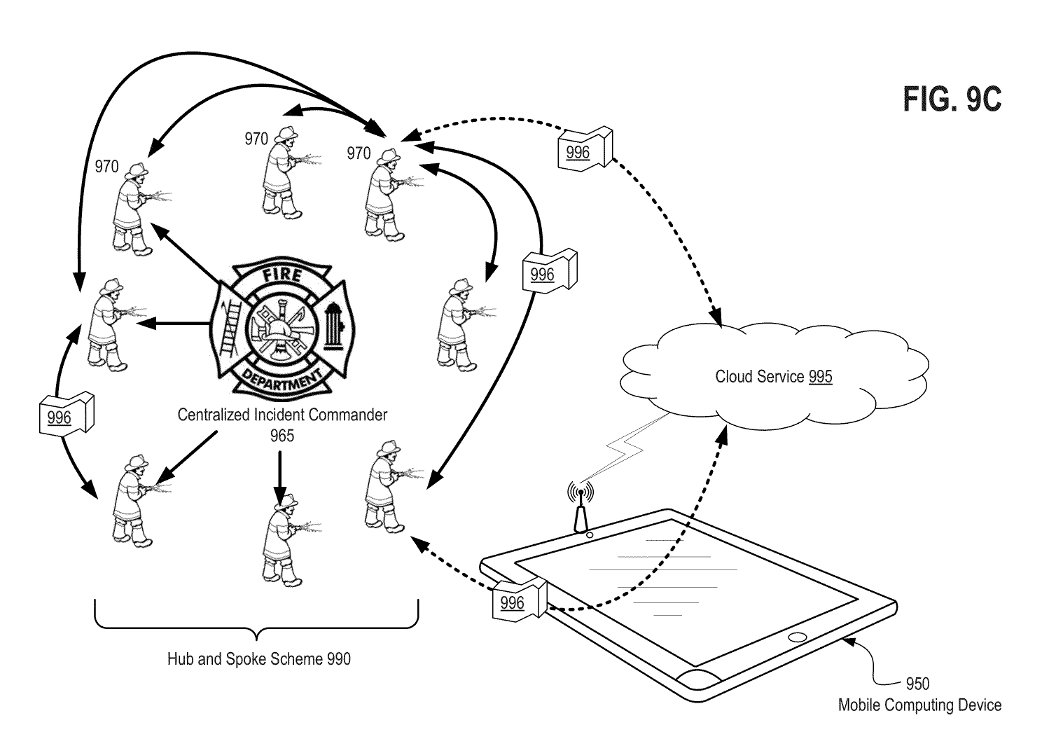

FIG. 9A depicts a cloud service 995 interacting with a mobile computing device 950, in accordance with one embodiment. In particular, there is depicted non-digitized reference materials 935 and 940, such as field manuals, schematics, protocols, forms, work flows, and other relevant information for First Responders along with database or other digitized resource having third party provided field manuals 925 and another database or digitized resource having internal and branded manuals 930.

The depicted cloud service 995 provides aggregation 905 (and digitization as necessary) of the non-digitized reference materials 935 and 940 as well as the third party provided field manuals 925 and internal and branded manuals 930. The cloud service 995 then provides curation 910 of the aggregated data and ultimately the cloud service 995 provides dissemination 915 of the aggregated and curated data to mobile computing devices 950 such as that which is depicted.

First Responders are responsible for and engaged directly in many actions and activities such as responding to motor vehicle accidents but are also frequently engaged in activities beyond those associated with motor vehicle accidents. First Responders such as firefighters and field deployed medical personnel therefore must reference a large body of information, much of which historically has not been provided in a modernized format, often existing quite literally in books, binders, and even printed forms and cards necessitating the First Responders to either forgo having such information with them due to its lack of mobility or to carry these physical reference materials with them, sometimes carrying field manuals on their body. Obviously the requirement to carry such physical reference materials greatly limits the amount of information that may be carried and accessed at any given time as well as being generally cumbersome.

Despite this longstanding problem, the market has failed to provide a solution specifically for the implementation and utilization of an incident response information management solution for First Responders.

The cloud service 995 depicted here provides such a management solution for First Responders by building the varied actions that First Responders participate into what may be considered differing layers for the various types of information that could be brought to bear by First Responders out in the field in a completely different way than any such information is conventionally delivered to them.

FIG. 9B depicts first responders 970 interacting with a centralized incident commander 965 and a cloud service 995 interacting with a mobile computing device 950, in accordance with one embodiment. The cloud service 995 remains in communication with the mobile computing device 950 via network communications 996, for instance, via a Public Internet or other communications network. Additionally depicted is the display of a cloud service interface 997 via the mobile computing device 950.

Conventionally, First Responders 970 interacted with a centralized incident commander 965 in a type of a hub and spoke scheme in which the First Responders were enabled to communicate with the centralized incident commander 965 acting as the hub with the various First Responders being the spokes. Unfortunately, there was no means by which the First Responders 970 could access information independently nor could the First Responders 970 interact with one another or provide information to one another in any meaningful way without going back through the centralized incident commander 965 operating as the hub.

Adding additional complexity, typically there would also be a dispatch person in a centralized location who would then in turn communicate with the centralized incident commander 965 at the hub who then communicates via radio or via other means with the individual firefighters or other First Responders in the field attending to the incident.

Conversely, the cloud service 995 places powerful tools such as information management resources directly into the hands of the individual First Responders 970 without having to abandon the hub and spoke scheme 990 which remains relevant for other functions. Nonetheless, enabling the First Responders 970 direct access to information via the cloud service 995, for instance, via the depicted mobile computing device 950, puts tools into their hands of the individual firefighters and First Responders 970 so that they may use those provided information resources to operate more independently, thus freeing up the centralized incident commander to attend to other functions besides information retrieval and dissemination of, for example, protocols and procedures provided by the various information sources depicted at FIG. 9A.

Such a structure thus avoids the human bottleneck completely as the First Responders 970 are able to bypass the centralized incident commander 965 for the purposes of information retrieval via the dissemination 915 function of the cloud service 995. In doing so, no longer is there a literal human information chain required from a dispatch person (e.g., for information not on-site with the incident commander) to the centralized incident commander 965 and then to the particular First Responder 970 requesting information. The model allows the centralized incident commander 965 to delegate or forgo much of the responsibility of information dissemination to the cloud service 995, thus freeing resources and improving efficiency.

FIG. 9C depicts first responders 970 interacting amongst themselves as well as with a cloud service 995 through a mobile computing device 950, in accordance with one embodiment.

In addition to relieving the centralized incident commander 965 of the burden of information dissemination, the model additionally enables information distribution at the edge of the hub and spoke scheme 990 by allowing the first Responders 970 to share information 996 amongst themselves, interact with one another to the extent permissible by their protocols and rules of engagement, and interact with and exchange information 996 with the cloud service 995 through the mobile computing device 950. For instance, interactions between two or more of the First Responders 970 may be communicated via an application on the mobile computing device as facilitated by the cloud service 995, all the while bypassing the centralized incident commander 965, thus forming a type of ring network or wheel communication scheme rather than necessitating information flow through a human centralized incident commander 965 operating as a hub in the hub and spoke scheme 990. One could argue that the cloud service 995 forms a kind of centralized hub if the First Responders interact with one another through the cloud service 995, but that is besides the point, as the cloud service 995 is computer implemented and not human dependent, and as such, the cloud service 995 is not subject to the same kind of bottleneck as is common place with all but the smallest public safety incident responses as it is all to easy to overwhelm a single point of contact when that single point is the human centralized incident commander 965 who's resources can be better utilized for other functions.

In such a way, information is released from, for example, the Fire Engine having a fixed management system by and through the centralized incident commander 965 on scene and into the hands of users who are moving around at the scene, thus making the information mobile rather than fixed in place. The system additionally frees the First Responders 970 from having to shuttle around books and binders and provides them with a vast amount of readily accessible information via the cloud service 995 through their mobile computing device 950 as the First Responders move about the incident scene.

Take for example a more extreme public safety incident response involving a hazardous materials or hazmat incident in which the firefighter is a mile away from the centralized incident commander 965 who is staged at the scene perimeter. Such a First Responder has a tool in his hand via the mobile computing device 950 that is usable while out in the field to not just receive information from the cloud service, but also to gather information regarding the incident. Multiple such First Responders may thus gather information concurrently, feeding the information back from the incident scene and into the cloud service without overwhelming the centralized incident commander 965 with the requirement of data entry for information coming in via radio and further enabling the centralized incident commander 965 to reference and access the information being collected directly from the field by the First Responders by utilizing the cloud service 995 in a similar manner to that of the First Responders, except with the centralized incident commander being a consumer of the data rather than a provider. In such a way, the power of information is placed into the hands of both the First Responders and also the centralized incident commander in real time without the human bottleneck problem as described above. No longer must the First Responders carry books or binders or rely upon the centralized incident commander to communicate reference information such as protocols and procedure, but instead, the First Responders are self sufficient and may operate more independently while simultaneously freeing the limited resources of the centralized incident commander to focus on other tasks.

While it may sound strange to discuss such fundamentals at this time, the harsh reality is that the marketplace has ignored this need of First Responders. Regardless, described herein are solutions that go well beyond providing information to First Responders 970 via a cloud service as the described methods and systems for implementing an incident response information management solution for First Responders provides additional efficiencies such as geographic mapping of incident variables, data collection which may be utilized for the completion of forms and required reporting that historically were completed via paper, as well as novel incident coordination schemes which are not feasible using the conventionally available technologies.

For instance, many local fire departments continue to use forms that are printed out on paper which require various boxes to be checked and information filled out, with the forms then being archived, not readily accessible via any computerized scheme. Moreover, the same information is very often required in multiple places across a series of forms. Thus, another provided function of the cloud service 995 is to capture information in the field via the First Responder users of the mobile computing device 950 and then utilize that information to aid in the completion of the forms, many of which are required to be completed by the First Responders, leading to dreaded paperwork. Such a scheme being more efficient thus frees the First Responders to focus on training and exercise in their more substantive duties, rather than merely completing forms and questionnaires regarding an incident.

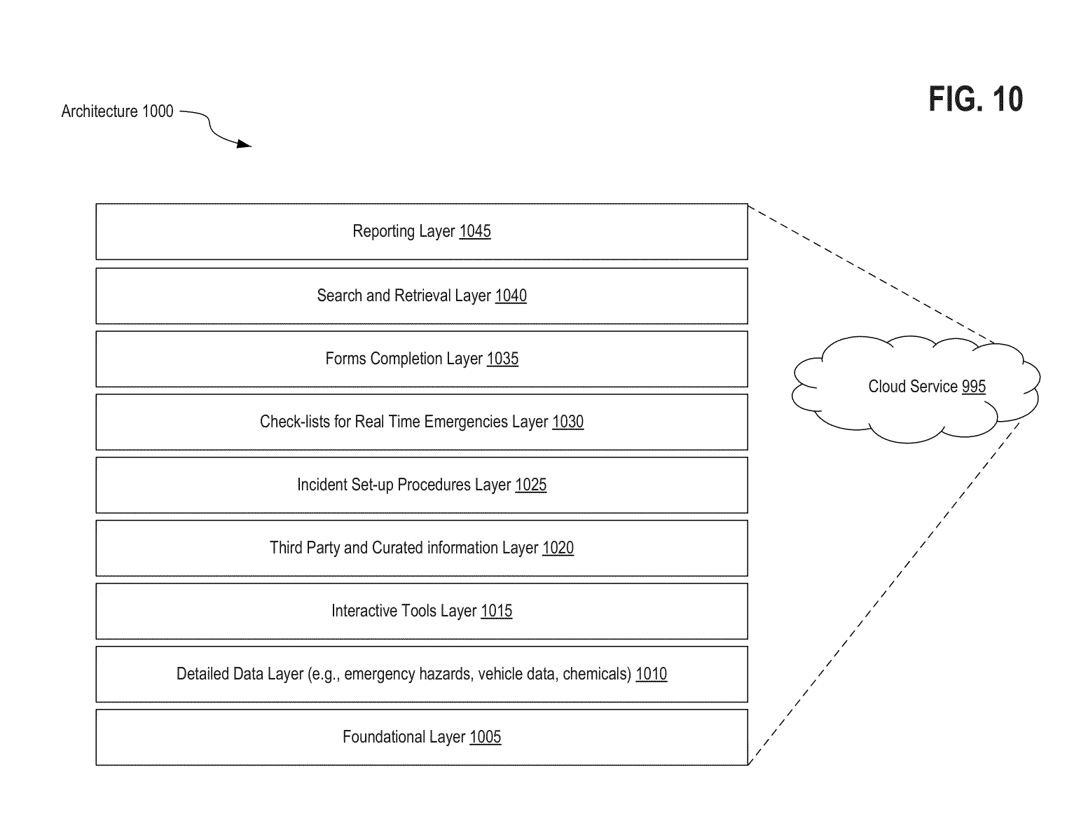

FIG. 10 depicts an exemplary architecture 1000 in accordance with described embodiments.

Starting with the bottom most layer, the foundational layer 1005 provides for information aggregation, data search, and information retrieval and dissemination as described above.

The detailed data layer 1010, provides detailed data about emergency hazards such as vehicles and chemicals, for instance, retrievable based on a license plate, a VIN, a make/model description, a chemical name, a picture of a chemical cargo sign or a hazmat sign, ad so forth.

The system provides access to resources which may be specifically rebranded for individual customers and limited to access by that customer. For instance, while the system provides access to a large collection of information, it is common for a particular group of First Responders, such as a specific fire department, to have its own manuals and reference materials. Such materials are not relevant to other fire departments and may not even be appropriate for sharing with them. The detailed data layer 1010 thus provides a re-branding and lanchpad facility where the customer may upload and store whatever information they please, re-branded as being their own local resources (e.g., Fire Department XYZ procedures), which is then made accessible through the detailed data layer 1010 of the cloud service along with the other information and tools provided. In such a way, even information which is wholly outside of the control or knowledge of the service provider, yet is of some importance to the particular users may be accessible through the same cloud service interface, specifically, via the detailed data layer 1010. A single user may also have multiple re-branded launch pads. For instance, Fire Department XYZ may have a launch pad via detailed data layer 1010 which is specific to their fire related resources and a launch pad specific to their medical related resources. Using the launch pad at the detailed data layer, they can input their own resources such as a fire and medical related resources, and then access the same via buttons provided via the detailed data layer 1010 such that the local re-branded information is provided along side with and in the same manner as, for example, curated and aggregated information available via the third party and curated information layer 1020.

The detailed data layer 1010 additionally provides information by incident type. For instance, one incident may be a hazardous materials incident whereas another incident type is a vehicle incident. Each is accessible via detailed data layer 1010, regardless of whether the information being accessed is provided by the cloud service or re-branded data belonging to a particular department of First Responders.

The interactive tools layer 1015 provides interactive tools which the user may employ to merge detailed data layer 1010 data with incident-specific information, such as vehicle impact locations and localized maps showing safety perimeters for specified chemicals.

The third party and curated information layer 1020 includes third party and edited guide information describing how to address the emergency hazards in the event of an incident. The previously non-digitized reference materials 935 and 940, such as field manuals, schematics, protocols, forms, work flows, and other relevant information for First Responders along with database or other digitized resource having third party provided field manuals 925 and another database or digitized resource having internal and branded manuals 930 may thus be directly accessible via this layer.

The incident set-up procedures layer 1025 includes incident set up procedures, incident control hierarchies, incident resource requisitions and task assignments. Conventional hub and spoke structures requires the dispatch to communicate information to the incident commander and the incident commander then in turn manages the First Responders out in the field. Utilizing the incident set-up procedures layer 1025, areas of responsibility may be assigned through the cloud service 995 and the responsibility of entering information associated with the assigned task is then delegated to the individual First Responder, thus being made more autonomous as is described above. With the First Responders which operate as spokes in the hub and spoke scheme being able to communicate amongst themselves at the edge as well as collect information from the field which is fed back into the cloud service from the edge, information is collected and returned to the centralized location via the cloud service 995, but without burdening the centralized incident commander.

With respect to task assignments specifically, consider for instance a large wildland fire with many different groups of First Responders. Some of the First Responders are responsible for actually putting out the fires, and thus, they are the “boots on the ground.” Some of the First Responders are medical personnel responsible for providing medical treatment to fire fighters and civilians and generally tending to injuries. The incident commander is central and with the conventional techniques must receive information back from the individual First Responders and then enter, or have his team enter, information into the incident management system. With the techniques described herein, the information is entered by the First Responders in the field, thus relieving the centralized incident commander of this burden, and the information is immediately available to the centralized incident commander.

For example, the medical personnel may gather and enter HIPPA (Health Insurance Portability and Accountability Act) compliant data about particular patients and fire fighters may gather and enter data about lines and positions and speed of advance and micro-localized wind conditions, etc.

With the information having been entered (e.g., via the forms completion layer 1035 described below), the incident commander can then pull in resources from a high level view, such as how many First Responders are deployed to a particular fire line, or alternatively drill down and look at more detailed resources such as a particular paramedic team deployed to the field, the number of patients being treated, a triage status for those patients, time deployed for the unit individuals (e.g., time in field), etc.

The centralized incident commander may also use the information entered by the deployed First Responders and retrieved by incident command from the cloud service 995 to move assets or alter assignments via the incident set up procedure layer 1025 to provide or update resource allocation as the incident dynamically evolves. For example, the incident commander may observe through the data retrieved that a single paramedic unit has two criticals, two deceased, and two injuries that are of the nature they may wait. In such a way, the incident commander may provide remote triage and then proceed to move assets in a way that is more informed and provide resource allocation to the most appropriate locations, such as the paramedic unit overwhelmed with the two simultaneous critical injury victims.

Furthermore, additional resources may be established geographically relative to the asset of concern. For instance, it may be that a helicopter medevac is needed near the paramedic unit having the two deceased and two critical injury victims, which the incident commander may establish via the incident set-up procedures layer 1025 and then effectuate via the same. The additional resource, such as a helicopter medevac, may be deployed in a geographic location relative to another asset or resource, such as the paramedic unit already deployed. The deployed resource will be displayed on the map and the new resource can be dragged and dropped on the map in a location chosen by the incident commander and when submitted, the geographic location is communicated to the resource to be deployed as an instruction to deploy at that location.

In such a way, the incident commander is availed of both a high level overview and additionally, if desired, a detailed or granular drill down view, for instance, of specific teams deployed or even specific individuals which make up such teams.

Considering again that the centralized incident commander acts in a type of hub position and role, it is in accordance with related embodiments that task assignments and resource deployments may additionally be coordinated via the incident set-up procedures layer 1025 by the deployed teams themselves, importantly, without having to go through the centralized incident commander at the hub position. Thus, deployment decisions, re-allocation of resources, and task assignments may be determined and effectuated at the edge, with the First Responders and their respective teams making such decisions and carrying them out by instructing one another at the edge of the hub and spoke model rather than communicating back through the hub from the spokes.

Consider, for example, two fire divisions deployed at the large wildland fire described above, one of whom is overwhelmed and one being under-utilized. A division commander deployed in the field (e.g., at the spoke) may bypass the centralized incident commander and communicate a re-assignment or instructions to move position to the other division commander, thus changing the deployment instruction of the other fire division via the incident set-up procedures layer 1025. For instance, the under-utilized fire division may be instructed to move by the division commander of the overwhelmed fire division or the under-utilized fire division may institute instructions via the incident set-up procedures layer 1025 to relocate itself, or re-deploy, such that it is in another position where it may come to the aid of the over-whelmed fire division.

In such a way, the conventional hub and spoke hierarchy may be maintained and utilized for task assignments, deployments, resource allocations, etc., or the centralized incident commander may be bypassed with the deployed teams making such decisions pertaining to deployments, assignments, and resource allocations, etc., subject to configurable restrictions pre-applied via the cloud service's interface by, for example, ranking officers for the First Responder units.

This may be beneficial especially with respect to specialty roles and teams whose needs and appropriate location may be understood by the deployed field units prior to the centralized incident commander becoming aware of the need and carrying out appropriate assignment and deployments. Again, the rank and authority of superiors may still be observed through simple restrictions that permit or deny various types of assignments and deployments according to a configurable rule set established in advance or in-situ via the incident set-up procedures layer 1025.

In a related embodiment, a division commander deployed in the field may input a re-assignment or instructions for the other fire division to move position, thus changing the deployment instruction of the other fire division via the incident set-up procedures layer 1025, but the re-assignment instruction is received by the cloud service and treated as a request which is then subject to approval by the centralized incident commander who is able to view the request as well as the present positions and proposed positions on a geographic map, and then making an approval or denial decision, but without having to input or coordinate the initial request. In such a way, a partial delegation of task assignment and re-allocation of resources may be instituted. This allows the incident commander to have a view of the incident scene along with proposed changes and the authority to approve or deny of those changes, but without necessitating the incident commander to control the entire information flow and act as a human bottleneck with respect to the entry of the request and proposal of the change.

Even if the incident commander assigns all tasks at the beginning through the incident set-up procedures layer 1025, the dynamically changing scene may nonetheless be accommodated in a more real-time fashion by permitting a delegation of at least some of the responsibilities of the incident commander to deployed First Responders and their unit leads or division commanders, as considered appropriate by the centralized incident commander and as enforced by the configurable rules provided by the incident set-up procedures layer 1025.

The check-lists for real time emergencies layer 1030 includes checklists designed for use in real time in emergency scenarios, acknowledging the use of personnel and resources and the performance of tasks related to emergency hazards and guides. The check-lists for real time emergencies layer 1030 also includes hierarchal tables and chronological tables and standardized chronological incident tables. For example, a First Responder proceeding though an incident may mark the time and sequence along with other details such as action taken and location of that action, as the various tasks for an incident are carried out.

First Responders commonly utilize checklists for a variety of incidents and part of using those checklists is to capture the time and sequence of the various functions performed. In reality, conventional checklists are on paper and the First Responders tend to fill out the time and sequence information later, subsequent to leaving the incident scene, rather than in real-time, at the accident scene. This is because the time and sequence data has conventionally been viewed as a reporting and paperwork task, however, use of the check-lists for real time emergencies layer 1030 provides the checklists via an interface which may be utilized as a tool for checking off the tasks as the First Responder progresses through them with the cloud service 995 automatically capturing the time, the sequence, and the location of the First Responder, thus automating this aspect of information capture and freeing the First Responder of the obligation. Other information regarding the tasks can be input at that time or input later, such as a cut location on a door of a vehicle. However, requiring only a subset of the information be manually entered greatly reduces the work load of the First Responder and thus, provides a natural incentive to utilize the technology, and through use of the technology, more accurate and complete information will be captured.

The check-lists for real time emergencies layer 1030 facilitates real time emergency scenarios by presenting standardized incident chronological tables. As different elements of the incident occur, and different functions occur in response to the incident, the first responders map those elements and functions using the standardized incident chronological tables such that the first responders may indicate progression through the incident response in a process flow through time, in step and in-situ with the incident response. In one embodiment a horizontal axis represents the flow through time and a vertical axis represents the functions performed at a specified stage or point in time as part of the incident response, which when complete, the standardized incident chronological tables outputs a report which includes the sequencing of events that occurred.

Standardizing the layers creates a format for guide information which has a compatible structure between the guides and the checklists and worksheets such that they may be linked together enabling information in one to be used by the others without having to re-enter or duplicate the information within the system.

The forms completion layer 1035 provides an interface for the electronic filling and completion of publically available government reports, many of which are very often required to be completed by First Responders, but with much of the information on the forms being automatically filled or populated for review via the forms completion layer 1035 utilizing the information the cloud service 995 has derived from information captured in the preceding layers, such as the information captured and known to the cloud service 995 based at least in part on the check-lists for real time emergencies layer 1030 and the incident set-up procedures layer 1025. Information that is known, such as incident type, incident location, assets and resources deployed, incident duration, tasks, and sequencing, etc., need not be remembered or manually filled into forms as this information exists within the cloud service for other purposes and can thus be re-used for the sake of the forms, again, freeing the First Responders to dedicate their limited time and effort to other tasks through improved efficiencies gained on required tasks, such as the completion of forms. Form elements that are not known already to the cloud service 995 may thus be input at the forms completion layer 1035 and the forms saved and submitted, all electronically via the forms completion layer 1035, for instance, at a mobile computing device communicatively interfaced to the cloud service 995.

The search and retrieval layer 1040 provides search and retrieval mechanisms for previous incidents.

The reporting layer 1045 includes reports using the data created in the preceding layers, including the incident set-up procedures layer 1025, the check-lists for real time emergencies layer 1030, and the forms completion layer 1035, each of which may have captured additional data about the incident relevant to any necessary final reporting.

In certain embodiments, access to a sub-set of the layers is restricted. For instance, layers 1025-1035 may be limited to a restricted to a restricted set of users according to rank or role. For example, maybe firefighters cannot see all the information or maybe lack access to certain of the layers, whereas a battalion chief can see everything and access all of the layers, as well as institute permissions and restrictions for delegating tasks, resource assignments and reallocations and so forth.

Navigation between the respective layers is available by selecting layer specific icons at an interface and once an incident is established, navigation may be done via a specific incident in which the layers seen and data viewable is filtered to a selected incident either during or after the incident response.

In such a way, the system puts the information into the hands of firefighters, police, and other first responders via a layered information structure such that they may retrieve the information in a more intuitive manner, faster, and have a greater access to information with powerful tools to search, sift, and filter so as to locate the appropriate information quickly. Within each of the layers the users are further enabled to navigate to the other layers thus enabling a sequential procedure where appropriate. For instance, initiating an incident response, selecting appropriate resources, filling forms and checklists, and reporting, etc. From the incident set-up procedures layer 1025 the user can then enter appropriate data and then navigate to the search and retrieval layer 1040 (via an interface or icon field which will be described later) and the navigation does not lose context of the incident which was initially set up, thus allowing for context appropriate searching and filtering. After searching for resources, the user may navigate to a checklist via the forms completion layer 1035 which identifies and displays the appropriate checklist(s) for completion based on the incident set up via the incident set-up procedures layer 1025

The user may identify department specific or general procedures specifying how to respond to the incident initiated via the set-up procedures layer 1025, where the procedures are taken from a public domain guidebook accessible to the cloud service 995 or provided by the users' department. The procedures may describe or recommend what kind of personal protective equipment the first responders should be wearing, for instance, where a house fire and an industrial chemical fire call for different kinds of safety equipment and even clothing. Narrative guides, written, audible, or otherwise, may also be provided to aid the navigation through the various layers or to aid the users in advancing through a given procedure established for the incident.

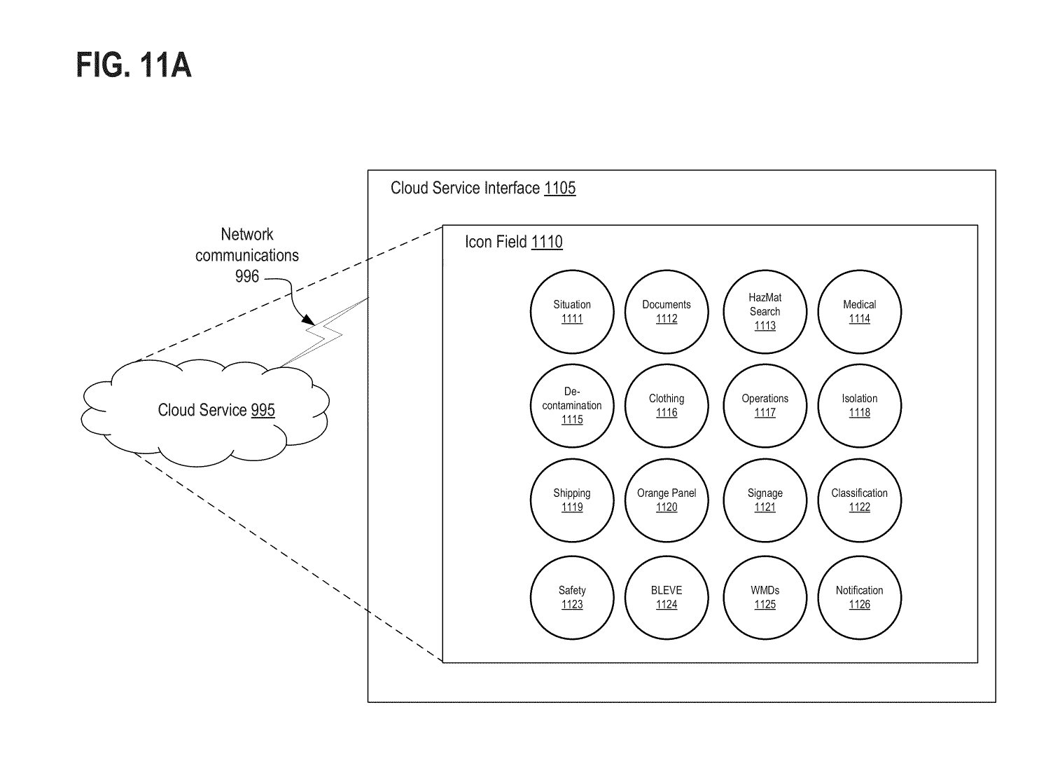

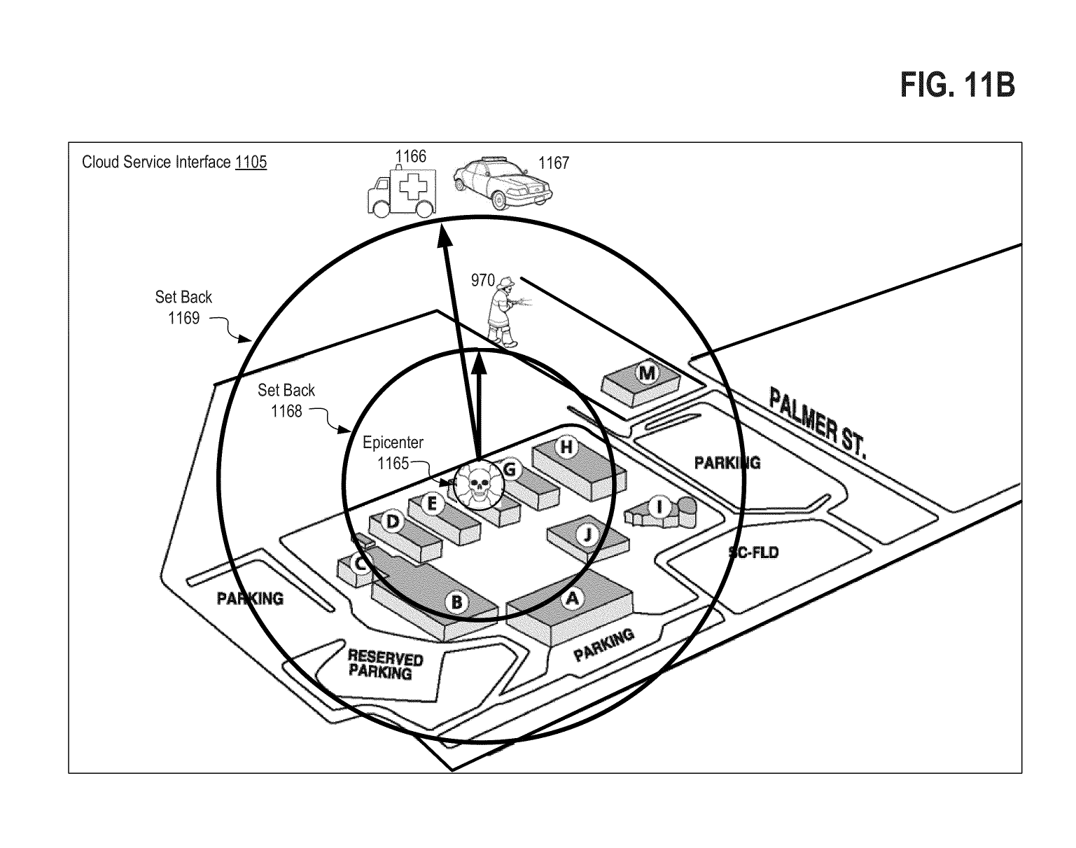

FIG. 11A depicts an exemplary icon field 1110 of a cloud service interface 1105 in accordance with described embodiments. Particularly described is the cloud service interface 1105 in relation to the cloud service 995 described earlier. The cloud service interface 1105 includes an icon field 1110 having therein multiple icons which may be customized by the clouds service 995 provider as well as in certain embodiments, by the users of the cloud service interface 1105.

In the particular embodiment depicted here there is a matrix of 16 icons, consisting of situation 1111, documents 1112, HazMat (e.g., hazardous materials) search 1113, medical 1114, de-contamination 1115, clothing 1116, operations 1117, isolation 1118, shipping 1119, orange panel 1120, signage 1121, classification 1122, safety 1123, BLEVE (Boiling Liquid Expanding Vapor Explosion) 1124, WMDs (Weapons of Mass Destruction) 1125, and lastly, notification 1126; although other icons, icon counts, and a different variety of icons are contemplated by the described embodiments.

According to one embodiment, the icon field 1110 is enabled via the interactive tools layer 1015 depicted by FIG. 10 which provides interactive tools that the user may employ to merge detailed data layer 1010 data with incident-specific information. The particular icons of the icon field 1110 are directly linkable to any of the functions and functionality provided by the various layers depicted by the architecture 1000 of the embodiment depicted by FIG. 10 and is customizable to link to any functionality provided by the cloud service 995.

In a particular embodiment, the icon field 1110 depicted may serve as an incident launch pad or a resource launch pad, from which users may select within a particular category of incident to either launch or begin their incident response or select appropriate resources, reference materials, etc., based on the particular category of incident selected, such as a HazMat search 1113 or a information pertaining to a particular vehicle type by selecting the documents 1112 icon, for instance. The users select what kinds of emergency response information they are interested in retrieving for a particular incident (e.g., such as HazMat search 1113 or medical 1114, or de-contamination 1115, etc) or based on the situation 1111, including searching for emergency response information or vehicle crash incident information, and so forth. Alternatively, the users may select appropriate icons from the icon field 1110 which facilitate the completion of worksheets, filling in checklists, etc.

Users may also use the various icons to retrieve information from publicly available information resources and databases. For instance, resources exist in the public domain which may be linked to and thus accessed from the icon field 1110 through the cloud service 995, such as information contained within an “emergency responders guidebook” or an “incident pocket resource guidebook” or the “fire scope guidebook” and so forth. In certain embodiments, extracts are provided from those resource guidebooks via the cloud service 995, made accessible via the icon field 1110. The information may curated such that chosen selections are provided, or made accessible in their entirety, or the information may be recast and rearranged by subject matter such that certain categories of information from multiple such resources are provided together. For instance, each of the above noted public domain resources includes a section on safety of hazardous materials and thus, the information pertaining specifically to the safety of incidents involving hazardous materials from the multiple guidebooks may be collated and presented in a single location for the user via one of the icons. Moreover, the icons may be context sensitive, such that if an incident is initiated for a particular vehicle type or for a particular chemical at an industrial fire, then the relevant context of those incidents (e.g., car type vs. the chemical at the industrial fire) will inform the search criteria utilized by the cloud service 995 to render the information. Stated differently, the user at the vehicle incident that selects hazardous materials from the icon field will be presented with documents and resources which are more likely to pertain to the types of hazardous materials for that given vehicle due to the context providing a priori information which may be utilized by a search or filter. Otherwise, generic information regarding hazardous materials may need to be further refined (e.g., by incident type, etc.) so as to be more useful to the first responder.

In such a way, the first responders attending to such incidents can retrieve everything that they might need to know about safety or decontamination or medical information, medical treatment policies or whatever kinds of relevant information may apply to a particular incident type, without having to carry dozens of physical paper copy guidebooks provided by the government.

Embodiments further support providing department based information to incident responders, including information which is not applicable to a given incident for all first responders, but rather, is applicable to a particular incident for first responders of a specific department or organization or jurisdiction. Such information may include, for instance, policy information for a given incident which may vary amongst the different groups of first responders and potentially even conflict, but nonetheless, remains applicable for the first responders of the given department or organization or jurisdiction. Consider for instance the policies regarding police engagement of with civilians, suspects, and victims in the various incidents that they respond to, in which the policies regarding their behavior must be adhered to by the police in a given jurisdiction, but are well known to lack consistency in many regards across disparate groups of police in different departments, organizations, and jurisdictions, etc.

That is not to say that any given policy is right or wrong as the underlying policy itself is immaterial. Rather, the appropriate policy for a given first responder in a given jurisdiction may be provided via the cloud service interface 1105 even where the policy information is not applicable to other jurisdictions. In certain embodiments, the information is provided by the first responders' department or organization or jurisdiction and uploaded to the cloud service 995 where it is then made available via the cloud service interface 1105. In other embodiments where the department or organization or jurisdiction specific information is available via a publically accessible resource it is retrieved by the cloud service 995 and provided via the cloud service interface 1105.

In a related embodiment information about personnel capabilities are provided by the cloud service 995 which is correlated to a subset of tasks that such personnel are authorized to perform, certified to perform, or capable to perform, such that the correlated information may be provided to the personnel in more streamlined manner. Specifically, where the system has knowledge of the tasks that such personnel are able to perform it can then filter or search based on that capability so as to present more context appropriate information to the particular individual user, even before the user begins inputting their own user specific search criteria or filters.

Government provided documents and resources are often organized in a narrative manner in which the user is intended to read through them sequentially, however, embodiments of the invention enable such documents to be broken down into subject area such that the user may search for, retrieve, and review them in any sequence and at any time. The resources may be re-combined in a different order or recombined with subsets of information taken from disparate government documents or other relevant resources to provide a customized view or a customized set of information suited to the particular users' needs.

Consider for instance an Emergency Resource Guide (ERG) that deals with hazardous materials and has a section called decontamination. Subsets of information from the ERG guidebook may be combined with information from other sources about decontamination and provided via the de-contamination 1115 icon. For example, perhaps the ERG has relevant decontamination information as does the EPA (Environmental Protection Agency) as does OSHA (Occupational Safety and Health Administration) as does the department's local resource guides, all of which may be broken up and recombined for presentment via the de-contamination 1115 icon.

Many other such examples exist. The ability to break down and recombine the information permits first responders faster access to specific information needed at the time of a particular type of incident, such as decontamination information, without having to sift through large volumes of physical reference materials.

In another embodiment the system incorporates information from prior experiences of first responders and provides the information along side other resources. For instance, firefighters responding to a vehicle incident may cut into a vehicle in a particular location and then when filling the forms and reports they may indicate the location of that cut on a particular vehicle type, for instance, by marking on a representation of the vehicle type the length and orientation of a cut. They may additionally indicate the time it took to make the cut as well as the effectiveness of the cut, or if another re-cut was necessary. The locations of the cuts for a given vehicle type may then be aggregated and presented to first responders involved with a vehicle incident for that vehicle type, in which a multitude of cuts from multiple incidents are presented (e.g., via a heat map or overlay, etc.) such that a first responder may assess where the most common or most effective cut point may be for that vehicle type. In one embodiment successful cuts may be marked one color, such as green, and unsuccessful cuts another color, such as red. This kind of information gathering is sometimes referred to as crowd sourcing and is made feasible through the cloud service 995 which not only pushes information to the first responders but receives information from them which may then be used to produce higher quality and more relevant information into the future. Here, however, the experiences of first responders responding to incidents and in particular, responding to a particular incident type, may record and then aggregate their experiences for the common benefit going forward. Moreover, a history of where cuts for a particular vehicle type may likewise be generated and represented via the cloud service interface 1105.

Consider that in 2012 alone, approximately 9.8 million passenger vehicles were involved in police-reported traffic crashes. While vehicles are becoming increasingly safe for their occupants during an accident, they are becoming increasingly complex and hazardous for responders afterwards. Air bags, struts, shocks and ultra high strength steel protect passengers but represent potential hazards for rescuers. In addition, the number of new electric vehicles on US roads has doubled over the last two years. Hybrid and electric cars produce up to 600 volts and 8 amps of electricity, sufficiently powerful to kill an ill-informed first responder or accident victim in a vehicle extrication situation. Even deactivating newer cars can be a challenge with 12-volt batteries hidden alongside radiators, under seats, in the rear of a vehicle or in special compartments under the hood. In accordance with one embodiment, the cloud service 995 provides a “Mobile Incident Management System” or “MIMS” which is accessible to first responders from the cloud service 995 via the cloud service interface 1105 at a mobile computing device. The Mobile Incident Management System aids first responders with information management issues, process flows, incident response procedures, and so forth, and in doing so, reduces the risks involved in responding to emergencies. With vehicle incident response specifically, the Mobile Incident Management System enables identification of the vehicle in the manner described above, enabling first responders or other users to search for passenger vehicles by license plate, by VIN, by year, make and model, easily identifying a particular vehicle in seconds. The Mobile Incident Management System further provides for information retrieval including vehicle reports for 30,000+ individual models dating back to 1981. These reports include vehicle diagrams, basic deactivation instructions and advice about hazardous components. The Mobile Incident Management System draws its resources from vehicle industry databases as well as state and government sources.

FIG. 11B depicts an exemplary cloud service interface 1105 of a cloud service provider in accordance with described embodiments. Particularly described is the cloud service interface 1105 described previously but now having a map layer over which there is an incident epicenter 1165 and a first and a second set back 1168 and 1169.

Consider for instance HazMat type incidents, layers of information may be presented to the first responder via the cloud service interface 1105 including, for instance, a base layer showing a satellite or grid type map view of an area as depicted by FIG. 11B, along with intermediate layers showing the hazardous materials, for instance, as input onto the map by incident command or another first responder at the scene and viewable by other first responders, and then upper layers having circles or ovals relating the types of hazard at that particular incident. For example, a larger outer circle may represent a civilian set back distance from the incident epicenter, another circle may represent a set back for other first responders such as medical personnel 1166 or police 1167 which are not actively attending to the incident itself, but rather, attending to human casualties, security, crowd control, and other activities associated with the incident (e.g., see set back 1169 depicted here as the outermost set back, the civilian set back not being depicted here due to space constraints). Another set back 1168 may represent the spread of a hazardous material and/or the distance for which first responders, such as firefighters 970 attending to the incident, must remain to be safe. The setbacks may not necessarily be circles, but other shapes to accommodate the hazardous materials, be they liquid, powders, gaseous, radiation, etc. For instance, a nebulous shape may show gaseous or ill defined contamination areas. A trapezium or trapezoid may show both directionality and spread. These circles and other shapes may be input by incident command or other first responders onto the map via the cloud service interface 1105 as described previously or may be calculated by functionality of the cloud service 995 based on inputs, such as wind direction, hazardous material type, volumes, etc.

According to the described embodiments, software for calculating the spread of such hazards ranging from radiation to gas to liquids and even the spread of large wild fires are accessible to the market place today and may be utilized by the cloud service 995 as turn-key solutions. Software may present a set back onto the map which is then manipulatable by incident command or first responders attending to the scene.

According to alternative embodiments, maps are provided via cloud service interface 1105 in accordance with applicable guideline specifications specifying safe distances from a particular hazard type as provided by and as determined by the department of transportation or other governmental agency for a relevant jurisdiction within which the hazard occurs. For instance, a hazmat rail car spill in Canada may have a different set back than the same incident in the United States or the United Kingdom, and as such, the appropriate set back 1168, 1169 is provided via the map as specified by the relevant governmental agency as determined from the geographic location or the responding group of first responders.

Regardless of what entity specified the set back distances, be they for civilian, first responders, hazmat teams, etc., subscribers utilizing the cloud service interface 1105 are able to modify the distances in depicted via the maps. The ability to modify may be configurable such that certain ranks or personnel may modify the distances or the modification ability may be disabled according to legal or jurisdictional requirements. The maps having the relevant set back, as provided or as modified, may be shared with other subscribers such (e.g., shared with the fire captain, incident commander, planner, or vice versa). According to particular embodiments, subscribers utilizing the cloud service interface 1105 publish and/or embed the maps on publicly accessible websites and make the makes available for viewing via broadcast during an incident response. In so doing, an incident specific evacuation map service is also provided to the public including providing real-time incident specific information which is consumable by news print websites and news broadcasts on the internet or television, using actual incident information as modeled by the first responders responding to that specific incident, rather than merely providing generic guidelines and stock information which lacks the benefit of real-time and current situational data.

In a related embodiment, viewing members of the public are therefore informed as to relevant dangers, evacuation routes, and specific instructions (e.g., shelter in place, evacuate, curfews, etc.) such that the public may be informed, in real time, as to precisely what the first responders are recommending and as to what the relevant jurisdictional government authority is specifically instructing. Because this information is not generic pre-planned stock data, the instructions and recommendations may change overtime as the incident response evolves, either through a de-escalation of the incident severity or an escalation of the incident severity.

According to certain embodiments, other user provided data is captured via a first user device at the cloud service interface 1105 and provided to other user devices via the cloud service interface 1105 at such devices. In such a way, crowd sourced data from first responders at a scene may be captured and shared or captured and stored for later retrieval.

For example, such data captured and shared may include the capture of incident user logs with automatically collected information including time-stamped and location-stamped action records (e.g., with device time or cloud based service provider time stamping and with geo-location data collected and associated with the time-stamped and location-stamped action records according to the user device's position at the time of recording). Other data captured may include manually triggered or automatically collected information such as photographs with date, time, location and image direction (e.g., orientation of the image's direction as N, S, E or W) data embedded into the photograph. Other examples include the capture and sharing of either recorded or live stream video also with date, time, location and image direction data embedded therein.

According to another embodiment, an entity creating the above noted materials via a user device or the cloud service interface 1105 may be person or a device such as a robot or drone. For instance, a user/author at a user device may be a first responder or there may be a non-human entity such as a drone which is linked into cloud service interface 1105 and collecting information in a semi-autonomous mode for upload and sharing or archive via the cloud service interface 1105.

In such embodiments, materials are recorded via a user device having the cloud service interface installed or embedded thereon as an application, a widget, a native application, a smartphone or tablet application from an app store, or the cloud service interface 1105 may be presented from within a browser interface or other display interface capable of presenting the cloud service interface 1105 provided by the cloud service 995. Network communications (e.g., 996 at FIG. 9B) with the user device may be used to provide other content to the user device or to the cloud service 995 via additional peripherals devices such as connected wireless devices such as wireless cameras.

According to a particular embodiment, materials captured or created including maps, user logs, photos, videos, etc., are captured and accessible pursuant to appropriate rights an authentication via unique web pages on a secure site. For instance, each quantum of material, such as a live streamed video, is available via a unique URL.

According to described embodiments, sharing with third party users may be managed by the author of the data. Sharing may be limited to individual subscribers or groups of subscribers or users meeting pre-determined criteria, such as role, rank, geographic proximity with the incident scene, and so forth. Sharing material permits a third party to have access to a unique URL from which they may view and access such data. According to one embodiment, recipients must be subscribers and the recipients retrieve the material via a list of accessible third party records or by clicking links to the material on a map. Such links will be represented as icons which are then accessed or opened by a gesture, clicking, mouse event, etc. According to a particular embodiment, unique users may contribute material to a group map of an incident over a period of time.

Use of the cloud service 995 and its tools enable first responders to make better and more informed decisions during a hazardous material emergency. Such high risk and complex situations present numerous challenges including fundamentals such as simply identifying where incident is located, what kinds of material have been spilled, whether there is a risk of fire, whether anyone has been injured or contaminated, how far back should the public and first responders of differing functions should remain be in order to remain safe, what kinds resources are available in-situ, and many other challenges. The traditional response to refer to pocket guidebooks such as the ERG, the NIOSH Guide and the IRPG hamper the efforts of first responders by being cumbersome to carry and difficult to navigate. Moreover, the chaotic nature of an incident creates a fog which makes referencing such materials at an incident scene quite difficult in reality and anything which simplifies the job of first responders' accessing the information they require can lead to improved safety and response. Prior solutions for hazmat incidents are designed for use on PCs and are simply not geared toward mobile devices nor do they permit the manipulation of incident variables at the scene by the first responders operating at the perimeter of the hub and spoke model. Other solutions are simply too difficult to utilize, for instance, requiring that a first responder remember how to correctly spell “Allyltrichlorosilane” in order to correctly search and identify appropriate response procedures (Allyltrichlorosilane is a colorless liquid with a pungent and irritating odor which is used in manufacturing to produce silicones and glass fiber finishes).

Conversely, the ability for first responders utilizing the cloud service 995 to generate and share maps and map features layered over the geography using incident variables specific to their present response efforts along with the ability to place resource icons at key locations can serve to improve the response effectiveness of our first responders. The cloud service 995 when utilized also provides automated recordation of key events within an event log, rather than requiring the first responders to spend time later entering such data or more likely, simply having response efforts which fail to capture such data which could potentially be of later benefit.

In a related embodiment the cloud service interface 1105 represents a particular vehicle type for a vehicle incident response in which the vehicle is represented at the epicenter 1165 of the incident and various hazards are depicted as circles emanating from or around the vehicle. In such an embodiment the vehicle may be represented on a map at its geographical location and then appropriate set backs represented onto the map via intermediate and upper display layers. Appropriate set backs 1168 and 1169 may be automatically represented onto the cloud service interface 1105 in relation to the vehicle based on the determined hazard for a given vehicle type, such as a first set back distance for gasoline and a different set back distance for a vehicle known to carry a propane tank or a hydrogen fuel cell vehicle. There may be smaller distance appropriate set backs for hazardous items such as air bags or other vehicular hazards that could injure civilians or first responders at the incident scene if they find themselves inside of the various set back distances. As described above, such data may be retrieved based on vehicle license plate recognition.

Standard mapping tool such as Google Maps or other providers may be utilized for the various layers such as the underlying map display layer. Wind direction information may be utilized to determine set back distances in conjunction with the vehicle type and hazard type, also usable as a turn-key solution or functionality by the cloud service 995 for use and presentment to the cloud service interface 1105. For instance, if the gas tank of a vehicle explodes, then there is a radius of that explosion which can be gathered or extrapolated and mapped. Information about perimeters is often provided via government resources which the cloud service 995 collects and then selects based on the hazard, vehicle type, and other filtering criteria.

In another related embodiment the cloud service interface displays icons over the incident and onto the mapping layer so as to depict where the incident commander wants to stage vehicles outside the range of a potential explosion or hazard area, such as where ambulances should be staged, where the medevac is to occur and where various other services and incident features shall occur such as medical facilities, exit routes, etc., all of which may be added to the map via layers which can be toggled on and off by the various first responders, incident command, and other users at the scene. For instance, icons may be placed onto the map corresponding to the firefighter 970, police 1167, and ambulance 1166, etc.

According to another embodiment safety set backs, such as those for civilians and press may be published in real time, for instance via twitter, Facebook, Google maps, and so forth. Such a publication provides a public service and may aid the first responders by diverting traffic away from the incident when such information is consumed by conventional navigation tools that utilize real-time road condition information. Such information when published may include the incident type, the hazard, the anticipated duration, evacuation directives, shelter in place commands, etc.

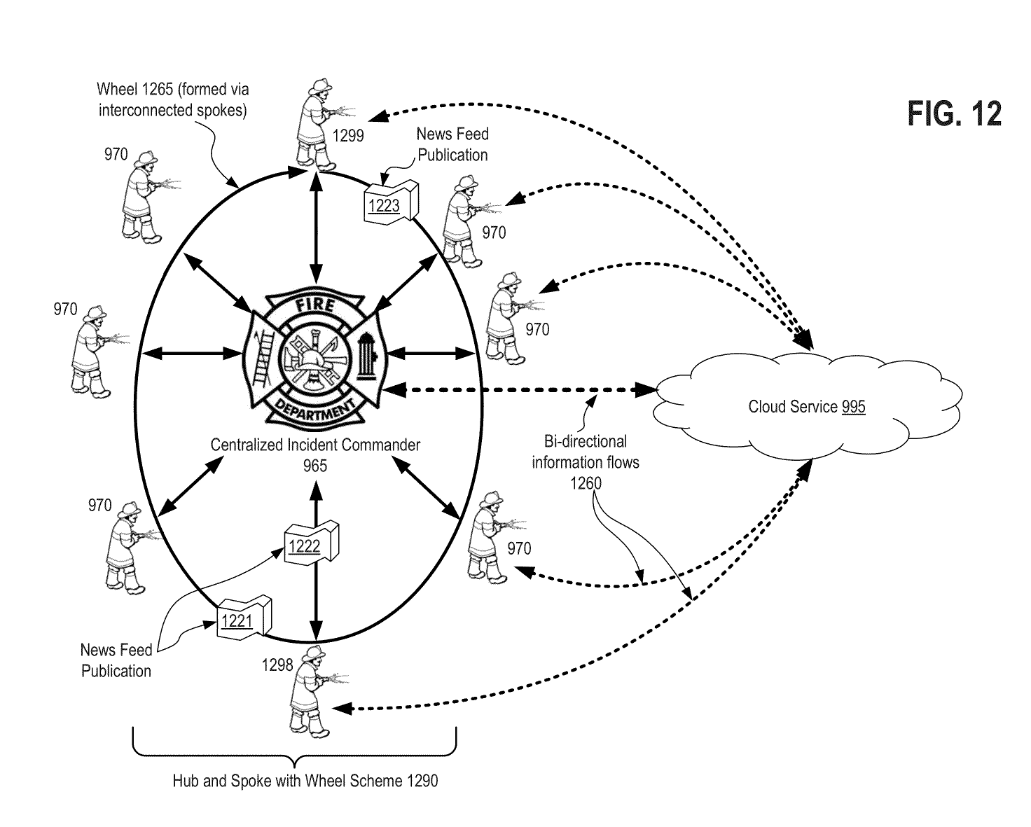

FIG. 12 depicts first responders 970 interacting amongst themselves as well as with a cloud service 995 via a hub and spoke with wheel scheme 1290, in accordance with described embodiments. The hub and spoke with wheel scheme 1290 is a more detailed representation of that which is depicted by the hub and spoke scheme 990 at FIG. 9C in which the first responders 970 communicate via the wheel 1265 formed via the interconnected spokes. Each of the first responders depicted here thus is enabled to communicate with any other first responders 970 present at the edge of the hub and spoke, thus along the edge or the wheel 1265, and each of the first responders 970 is further enabled to have bi-directional information flow 1260 with the cloud service 995, for instance, via a mobile computing device or cloud service interface 1105 as described above. The centralized incident commander 965 remains and has a bi-directional information flow 1260 with the cloud service 995 as well as communications with each of the first responders 970 represented at the edge or the wheel 1265.

Using conventional communication models, any information input or output into an incident management system must go through the centralized incident commander 965 in which a dispatch person tells the incident commander about the incident and then the incident commander manages everyone within the system forcing a rigid hierarchical structure. Use of the cloud service 995 in conjunction with the hub and spoke with wheel scheme 1290 depicted here permits the centralized incident commander 965 to assign areas of responsibility to users within the technology and then those users (e.g., first responders 970) at the edge or wheel 1265 are responsible for entering information into the system and pursuing and then completing tasks within the area assigned to them.

In such a way, multiple users may simultaneously contribute to a single information resource as opposed to limiting contributions to the information resource to only the centralized incident commander 965 at the hub. In such a way, the spokes emanating from the hub are communicatively joined at the edge to form the wheel 1265 which in turn enables greater communication options amongst the various individuals at an incident. By assigning tasks to the various first responders or other resources at the beginning of an incident through the incident set-up procedures layer 1025 (FIG. 10) the first responders are able to interact with the cloud service 995 through their mobile devices in a context appropriate manner, in which they see tasks and resources which are contextually appropriate for their assigned role, assigned position, and in which they are able to enter information into the system which may then be shared and viewed by others to form a complete information picture for the whole incident. Thus, not only does the centralized incident commander 965 benefit from the holistic view, but others involved in the incident likewise benefit from the more complete information picture.

In a particular embodiment, first responders deploy or re-position resources by moving icons on a mapping layer displayed to the cloud service interface 1105 and those changes are reflected at the cloud service interface 1105 of the other first responders 970 and the centralized incident command.

In accordance with another embodiment, first responders 970 on the edge or wheel 1265 trigger a news feed publication 1221, 1222, and 1223 when making changes on their display screen via the cloud service interface 1105 which then in turn is viewable by other first responders on the edge or wheel 1265 and optionally by the centralized incident commander 965. According to a particular embodiment, the news feed is conditioned on the role, rank, authority, or function of the first responder making the change and triggering the news feed publication 1221, 1222, and 1223. For instance, it may be that first responder 1299 is a division commander and when he makes a change to icons or resources displayed on the screen of his mobile computing device via the cloud service interface 1105, those changes are published to all other first responders 970 at the incident due to the rank and function of the division commander. In another embodiment, it may be that the first responder 1298 is a medevac personnel which moves additional medevac resources to his location. In one embodiment, due to the first responder's 1298 role the publication goes to the centralized incident commander 965 via a published news feed 1222 which is treated as a request for resources rather than a dictate to modify or move resources. Other examples exist and are configurable by the centralized incident commander 965 or by the cloud service during or in advance of an incident response. In other embodiments, first responders 970 may select to publish news feeds 1221, 1222, and 1223 to only a centralized incident commander 965 or to the entire brigade, or to their division commander, and so forth.

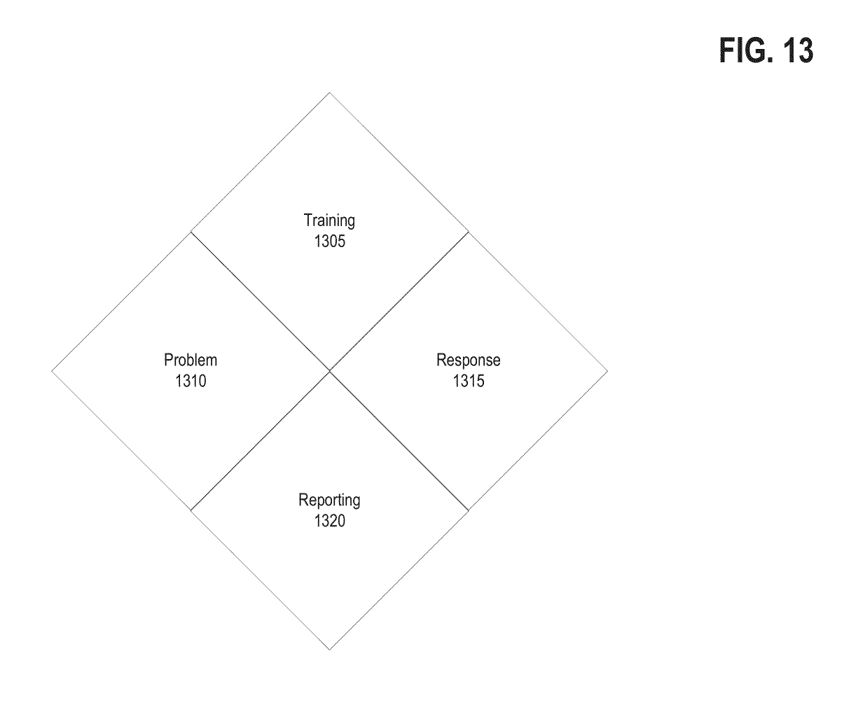

FIG. 13 depicts the primary actives that first responders are involved with according to the described embodiments. Before firefighters and other first responders engage an incident, they first engage in training 1305. When a problem 1310 occurs (e.g., an emergency), the firefighters response 1315 is to attend to the emergency as a group. Lastly, they document what occurred through reporting 1320 procedures. Each activity of the quadrant involves activities which define the emergency service personnel's response to the incident.

The systems described herein provide support through each step of the training, problem, response, and reporting activities and is adaptable to many kinds of incidents such as vehicle and hazardous materials incidents which are described in some detail herein. Hazardous materials incidents may be further subdivided by type, such as structures, road trailers, pipelines and rail containers, etc. The same model may be applied to natural disasters, wildland fires and structure fires, urban search and rescue, medical response and other incident types.

Reference materials for training purposes, hazard identification and other kinds of information retrieval aid the first responders in dealing with problems they may encounter and form completion functionality such as an incident reporting tool provided via the reporting layer 1045 (FIG. 10) improves efficiency. Information collected during an incident response may be used to complete a report as well as used by other first responders at the same incident in real-time during the incident response.

When an incident occurs, the first thing an emergency responder needs to understand is the nature of the problem 1310. Can the first responders identify the cause of the problem? What was it? What impact did the problem have? What risks are the responders facing and what precautions and measures should they take? According to one embodiment the system divides these questions into two basic elements: Identification and Risk Assessment.

Identification involves searching for information about the problem from a variety of databases. For vehicles, this includes license plate and VIN databases, photograph galleries and make-model-year-shape-propulsion type descriptions. For hazardous materials this includes alphabetical lists, identification numbers, placard types and vehicle types used for transportation purposes.

Risk Assessment involves reviewing resources for advice about the identified problem. For vehicles this means accessing vehicle industry reports about specified vehicles, vehicle diagrams and deactivation and repair and/or extrication resources. For hazardous materials this means retrieving guidance from government guidebooks for specified chemicals describing chemical toxicity, the type of clothing and protective equipment a responder should wear, first aid and decontamination procedures, protective action distances and other risk mitigation methods.

The system provides vehicle diagrams to responders and in the case of hazardous materials, offers safety maps/satellite views which are interactive during the course of the incident response and may additionally be preserved for future retrieval and reporting.

Each new incident creates a database record and incident identity and details for that incident are recorded and assembled in the database and associated via the incident identity. Incident updates are unified into a summary table and can be retrieved subsequently.

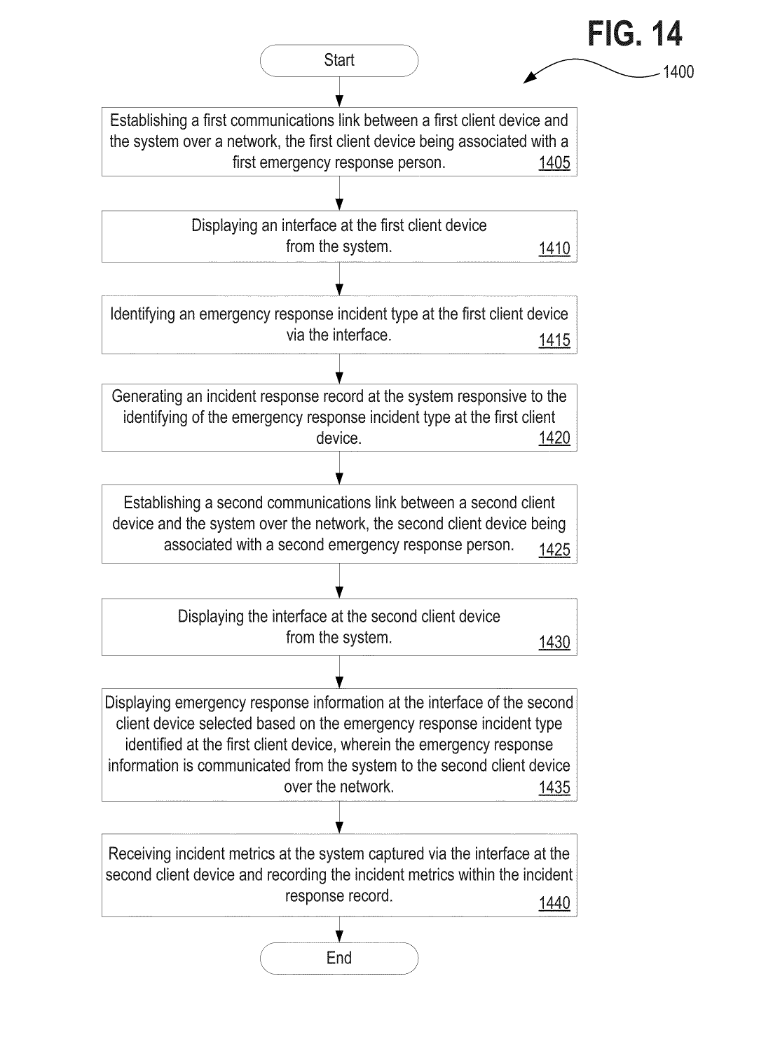

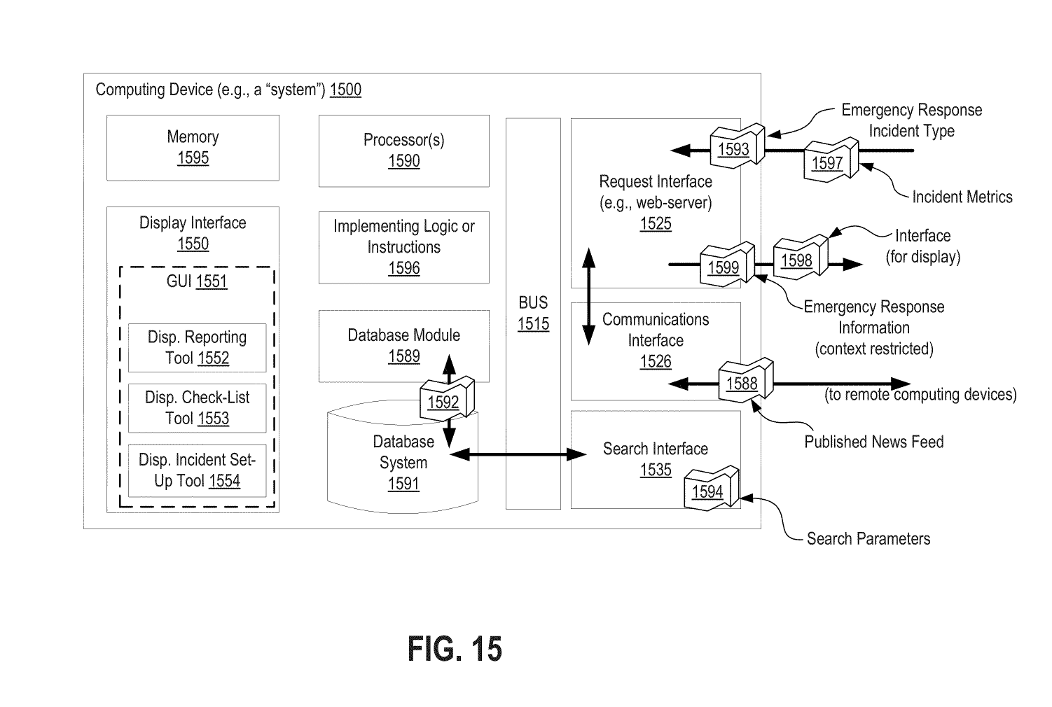

FIG. 14 is a flow diagram illustrating a method 1400 in accordance with disclosed embodiments. Method 1400 may be performed by processing logic that may include hardware (e.g., circuitry, dedicated logic, programmable logic, microcode, etc.), software (e.g., instructions run on a processing device to perform various operations such as establishing, displaying, identifying, generating, receiving, navigating, applying, loading, exchanging, executing, capturing, transmitting, sending, etc., in pursuance of the systems, apparatuses, and methods for implementing an incident response information management solution for First Responders, for instance, as implemented via the system 500 at FIG. 5, the Smartphone or Tablet Computing Device 601 at FIG. 6, the tablet computing device 701 or hand-held smartphone 702 at FIG. 7, the machine 800 at FIG. 8, the system 1500 at FIG. 15, and the other computer architectures depicted herein, each of which may implement the described methodologies. Some of the blocks and/or operations listed below are optional in accordance with certain embodiments. The numbering of the blocks presented is for the sake of clarity and is not intended to prescribe an order of operations in which the various blocks must occur.

With reference to FIG. 14 and method 1400, processing logic establishes a first communications link between a first client device and the system over a network, the first client device being associated with a first emergency response person (block 1405).

At block 1410, processing logic displays an interface at the first client device from the system.

At block 1415, processing logic identifies an emergency response incident type at the first client device via the interface.

At block 1420, processing logic generates an incident response record at the system responsive to the identifying of the emergency response incident type at the first client device.

At block 1425, processing logic establishes a second communications link between a second client device and the system over the network, the second client device being associated with a second emergency response person.

At block 1430, processing logic displays the interface at the second client device from the system.

At block 1435, processing logic displays emergency response information at the interface of the second client device selected based on the emergency response incident type identified at the first client device, wherein the emergency response information is communicated from the system to the second client device over the network.

At block 1440, processing logic receives incident metrics at the system captured via the interface at the second client device and recording the incident metrics within the incident response record.

It is therefore in accordance with the various described embodiments that there is a method 1400 to execute within a system having at least a processor and a memory therein, in which the method 1400 includes: establishing a first communications link between a first client device and the system over a network, the first client device being associated with a first emergency response person; displaying an interface at the first client device from the system; identifying an emergency response incident type at the first client device via the interface; generating an incident response record at the system responsive to the identifying of the emergency response incident type at the first client device; establishing a second communications link between a second client device and the system over the network, the second client device being associated with a second emergency response person; displaying the interface at the second client device from the system; displaying emergency response information at the interface of the second client device selected based on the emergency response incident type identified at the first client device, in which the emergency response information is communicated from the system to the second client device over the network; and receiving incident metrics at the system captured via the interface at the second client device and recording the incident metrics within the incident response record.

In accordance with another embodiment of the method 1400, the first client device functions as incident command; in which the second client device functions as one of a plurality of first responder roles allocated by the incident command at the first client device.

In accordance with another embodiment of the method 1400, the plurality of first responder roles allocated include one or more of firefighters, division commanders, medevac personnel, hazardous material handlers, decontamination personnel, ambulance medics, police, and communications operators.

In accordance with another embodiment of the method 1400, receiving incident metrics at the system captured via the interface at the second client device includes the second emergency response person inputting the incident metrics at the second client device via the interface; and in which the incident metrics include one or more of: incident actions, timing information for incident events, sequencing information for incident events, resource re-allocation request, first responder movement request, updated safety set back, updated incident type information, hazardous material identification, and contamination area information.

In accordance with another embodiment of the method 1400, receiving incident metrics at the system captured via the interface at the second client device includes the second emergency response person moving icons on a map displayed at the interface of the second client device; and in which the icons moved on the map displayed at the interface of the second client device triggers corresponding icons displayed at the interface of the first computing device to be relocated to a new position corresponding to the position of the icons moved on the map displayed at the interface of the second client device.

In accordance with another embodiment of the method 1400, changes at the second client device trigger a news feed publication from the second client device to a plurality of other client devices associated with the incident response record.

In accordance with another embodiment of the method 1400, the news feed publication is conditioned on the role, rank, authority, or function of a First Responder associated with the second computing device subsequent to making the changes at the second computing device and triggering the news feed publication.

In accordance with another embodiment of the method 1400, changes at the second client device trigger a news feed publication from the second client device to a subset of a plurality of other client devices associated with the incident response record; in which the subset is specified via input received at the interface of the second computing device; and in which the subset includes the news feed publication being pushed to one or more of: a centralized incident commander, a firefighter brigade, a division commander of a user associated with the second client device, or a specified one or more users of other client devices associated with the incident response record.

In accordance with another embodiment, the method 1400 further includes: associating other client devices with the incident response record by authenticating the other client devices through the system hosted by a cloud service, in which the association is determined based at least in part on association between each of the other client devices with the first client device having generated an incident response record at the system.

In accordance with another embodiment of the method 1400, a host organization implements the method via computing architecture of the system including at least the processor and the memory, the system operating at the host organization; in which the host organization operates as a cloud based service provider to the first and second client device and the other client devices associated with the incident response record; and in which each of the respective client devices communicate with the cloud based service provider via a network and authenticate through the cloud based service provider responsive to which the cloud based service provider displays the interface to the respective client devices.

In accordance with another embodiment of the method 1400, the displaying the interface at the first and second client devices includes one or more of: displaying an icon field via a cloud service interface, the icon field to receive an icon selection from a user at the cloud service interface; displaying a map layer via the cloud service interface, the map layer having one or more additional layers displayed above it including at least a setback, an incident epicenter, and one or more icons, in which the setback, the incident epicenter, and each of the one or more icons are manipulatable at the cloud service interface; displaying a reporting tool via the cloud service interface; displaying a search and retrieval tool via the cloud service interface; displaying a forms completion tool via the cloud service interface; displaying a check-list completion tool via the cloud service interface; displaying an incident set up tool via the cloud service interface; displaying a third-party information search tool via the cloud service interface; displaying an emergency response information search tool via the cloud service interface; displaying a branded icon field via the cloud service interface having one or more icons which link to department specific procedures and information for first responders associated with the first and second client device; and displaying aggregated incident metrics from a plurality of past incident response records.

In accordance with another embodiment, the method 1400 further includes: establishing a third communications link between a third client device and the system over the network, the third client device being associated with a third emergency response person; in which the first client device functions as incident command; in which the second and third client devices are associated with First Responders allocated by the incident command at the first client device and not part of incident command; and in which the second and third client devices exchange incident metrics through the system without routing the incident metrics through incident command.

In accordance with another embodiment of the method 1400, displaying emergency response information at the interface of the second client device selected based on the emergency response incident type identified at the first client device, includes: displaying context restricted emergency response procedures at the second client device which are filtered on the basis of the emergency response incident type identified at the first client device; and in which the emergency response procedures include one or more of: a digitized display of reference materials provided by a government entity in a non-digitized format; third party provided manuals satisfying the filtering; and internally branded reference materials satisfying the filtering, the internally branded reference materials being specific to a group of first responders to which users of the first and second client devices are members.

In accordance with another embodiment of the method 1400, identifying an emergency response incident type at the first client device via the interface includes: a central incident command identifying the emergency response incident type via the first client device selected from one of: a vehicle crash incident; a hazardous materials incident; a wild fire incident; a house fire incident; a chemical fire incident; a natural disaster incident; and a flooding incident.

In accordance with another embodiment, the method 1400 further includes: displaying incident reporting forms and incident procedures at the interface of the first and second client devices based on the emergency response incident type identified by central incident command at the first client device.

In accordance with another embodiment of the method 1400, each of the first and second client devices each embodied within one of: a tablet computing device; and a hand-held smartphone.

In accordance with a particular embodiment, there is a non-transitory computer readable storage medium having instructions stored thereon that, when executed by a processor of a system, the instructions cause the system to perform operations including: establishing a first communications link between a first client device and the system over a network, the first client device being associated with a first emergency response person; displaying an interface at the first client device from the system; identifying an emergency response incident type at the first client device via the interface; generating an incident response record at the system responsive to the identifying of the emergency response incident type at the first client device; establishing a second communications link between a second client device and the system over the network, the second client device being associated with a second emergency response person; displaying the interface at the second client device from the system; displaying emergency response information at the interface of the second client device selected based on the emergency response incident type identified at the first client device, in which the emergency response information is communicated from the system to the second client device over the network; and receiving incident metrics at the system captured via the interface at the second client device and recording the incident metrics within the incident response record.

FIG. 15 shows a diagrammatic representation of a computing device (e.g., a “system”) 1500 in which embodiments may operate, be installed, integrated, or configured.

In accordance with one embodiment, there is a computing device 1500 having at least a processor 1590 and a memory 1595 therein to execute implementing logic and/or instructions 1596. Such a computing device 1500 may execute as a stand alone computing device with communication and networking capability to other computing devices, may operate in a peer-to-peer relationship with other systems and computing devices, or may operate as a part of a hosted computing environment, such as a host organization or a cloud based service provider which provides a cloud computing environment to, for instance, provide services on a fee or subscription basis.

The various components of system 1500 are interconnected via bus 1515. Request interface, communications interface, and search interface enable the system to communicate with systems and remote computing devices (such as the client devices described herein) in a bi-directional manner, including receiving, for instance, search parameters 1594 into the system 1500 via search interface and receiving and returning information to such client devices and remote computing devices via the communications and request interfaces.

According to the depicted embodiment, computing device 1500 includes a communications interface 1526 to receive a first communications link between a first client device remote from the system 1500 and the system over a network, the first client device being associated with a first emergency response person; a web-server 1525 to transmit an interface 1598 to a display at the first client device; the web-server 1525 to receive an indication of an emergency response incident type 1593 from the interface displayed at the first client device; a database module 1589 to generate and store an incident response record 1592 at the system 1500 responsive to the indication by the first client device of the emergency response incident type 1593; the communications interface 1526 to receive a second communications link between a second client device remote from the system 1500 and the system over the network, the second client device being associated with a second emergency response person; the web-server 1525 to transmit the interface 1598 to a display of the second client device; the web-server 1525 to transmit emergency response information 1599 for display at the interface of the second client device, the emergency response information 1599 selected based on the indication by the first client device of the emergency response incident type 1593, in which the emergency response information 1599 is transmitted from the system 1500 to the second client device over the network; the web-server 1525 to receive incident metrics 1597 captured via the interface displayed at the second client device; and in which the database module 1589 is to record the incident metrics 1597 within the incident response record 1592.

According to another embodiment, the system 1500 operates within a host organization to provide a cloud based service to the first and second client device accessible over a public Internet; in which the host organization comprises at least the system 1500, the web-server 1525, and a database system 1591; in which the database system 1591 is communicably interfaced with the database module 1589 of the system 1500; and in which the web-server 1525 is communicably interfaced to the first and second client devices via the public Internet to provide at least authentication services and transmission of the interface for display to the first and second client devices.

According to another embodiment, the system 1500 further includes a display interface 1550 having therein a GUI 1551 which is enabled to transmit for display at the interface 1598 any one of a display reporting tool 1552, a display check-list tool 1553, and a display incident set-up tool 1554.

According to another embodiment of system 1500, changes at the second client device trigger a news feed publication 1588 from the second client device to a plurality of other client devices associated with the incident response record and the communications interface 1526 of the system 1500 receives and re-distributes the published news feed 1588 to the plurality of other client devices associated with the incident response record. In a related embodiment, the news feed publication 1588 is conditioned on the role, rank, authority, or function of a First Responder associated with the second computing device subsequent to making the changes at the second computing device and triggering the news feed publication and the database module 1589 of the system 1500 queries the database system 1591 to determine the appropriate associations and to resolve the conditional news feed publication 1595 based on role, rank, authority, and function information stored in the database system 1591 for the plurality of other client devices associated with the incident response record.

While the subject matter disclosed herein has been described by way of example and in terms of the specific embodiments, it is to be understood that the claimed embodiments are not limited to the explicitly enumerated embodiments disclosed. To the contrary, the disclosure is intended to cover various modifications and similar arrangements as are apparent to those skilled in the art. Therefore, the scope of the appended claims are to be accorded the broadest interpretation so as to encompass all such modifications and similar arrangements. It is to be understood that the above description is intended to be illustrative, and not restrictive. Many other embodiments will be apparent to those of skill in the art upon reading and understanding the above description. The scope of the disclosed subject matter is therefore to be determined in reference to the appended claims, along with the full scope of equivalents to which such claims are entitled.

What is claimed is:

1. A method to execute within a system having at least a processor and a memory therein, wherein the method comprises:
establishing a first communications link between a first client device and the system over a network, the first client device being associated with a first emergency response person;
displaying an interface at the first client device from the system;
identifying an emergency response incident type at the first client device via the interface;
generating an incident response record at the system responsive to the identifying of the emergency response incident type at the first client device;
establishing a second communications link between a second client device and the system over the network, the second client device being associated with a second emergency response person;
displaying the interface at the second client device from the system;
displaying emergency response information at the interface of the second client device selected based on the emergency response incident type identified at the first client device, wherein the emergency response information is communicated from the system to the second client device over the network; and
receiving incident metrics at the system captured via the interface at the second client device and recording the incident metrics within the incident response record.

2. The method of claim 1:
wherein the first client device functions as incident command;
wherein the second client device functions as one of a plurality of first responder roles allocated by the incident command at the first client device.

3. The method of claim 2, wherein the plurality of first responder roles allocated include one or more of firefighters, division commanders, medevac personnel, hazardous material handlers, decontamination personnel, ambulance medics, police, and communications operators.

4. The method of claim 1:
wherein receiving incident metrics at the system captured via the interface at the second client device comprises the second emergency response person inputting the incident metrics at the second client device via the interface; and
wherein the incident metrics include one or more of: incident actions, timing information for incident events, sequencing information for incident events, resource re-allocation request, first responder movement request, updated safety set back, updated incident type information, hazardous material identification, and contamination area information.

5. The method of claim 1:
wherein receiving incident metrics at the system captured via the interface at the second client device comprises the second emergency response person moving icons on a map displayed at the interface of the second client device; and
wherein the icons moved on the map displayed at the interface of the second client device triggers corresponding icons displayed at the interface of the first computing device to be relocated to a new position corresponding to the position of the icons moved on the map displayed at the interface of the second client device.

6. The method of claim 1, wherein changes at the second client device trigger a news feed publication from the second client device to a plurality of other client devices associated with the incident response record.

7. The method of claim 6, wherein the news feed publication is conditioned on the role, rank, authority, or function of a First Responder associated with the second computing device subsequent to making the changes at the second computing device and triggering the news feed publication.

8. The method of claim 1:
wherein changes at the second client device trigger a news feed publication from the second client device to a subset of a plurality of other client devices associated with the incident response record;
wherein the subset is specified via input received at the interface of the second computing device; and
wherein the subset comprises the news feed publication being pushed to one or more of: a centralized incident commander, a firefighter brigade, a division commander of a user associated with the second client device, or a specified one or more users of other client devices associated with the incident response record.

9. The method of claim 1, further comprising:
associating other client devices with the incident response record by authenticating the other client devices through the system hosted by a cloud service, wherein the association is determined based at least in part on association between each of the other client devices with the first client device having generated an incident response record at the system.

10. The method of claim 9:
wherein a host organization implements the method via computing architecture of the system including at least the processor and the memory, the system operating at the host organization;
wherein the host organization operates as a cloud based service provider to the first and second client device and the other client devices associated with the incident response record; and
wherein each of the respective client devices communicate with the cloud based service provider via a network and authenticate through the cloud based service provider responsive to which the cloud based service provider displays the interface to the respective client devices.

11. The method of claim 1, wherein the displaying the interface at the first and second client devices comprises one or more of:
displaying an icon field via a cloud service interface, the icon field to receive an icon selection from a user at the cloud service interface;
displaying a map layer via the cloud service interface, the map layer having one or more additional layers displayed above it including at least a setback, an incident epicenter, and one or more icons, wherein the setback, the incident epicenter, and each of the one or more icons are manipulatable at the cloud service interface;
displaying a reporting tool via the cloud service interface;
displaying a search and retrieval tool via the cloud service interface;
displaying a forms completion tool via the cloud service interface;
displaying a check-list completion tool via the cloud service interface;
displaying an incident set up tool via the cloud service interface;
displaying a third-party information search tool via the cloud service interface;
displaying an emergency response information search tool via the cloud service interface;
displaying a branded icon field via the cloud service interface having one or more icons which link to department specific procedures and information for first responders associated with the first and second client device; and
displaying aggregated incident metrics from a plurality of past incident response records.

12. The method of claim 1, further comprising:
establishing a third communications link between a third client device and the system over the network, the third client device being associated with a third emergency response person;
wherein the first client device functions as incident command;
wherein the second and third client devices are associated with First Responders allocated by the incident command at the first client device and not part of incident command; and
wherein the second and third client devices exchange incident metrics through the system without routing the incident metrics through incident command.

13. The method of claim 1, wherein displaying emergency response information at the interface of the second client device selected based on the emergency response incident type identified at the first client device, comprises:
displaying context restricted emergency response procedures at the second client device which are filtered on the basis of the emergency response incident type identified at the first client device; and
wherein the emergency response procedures include one or more of:
a digitized display of reference materials provided by a government entity in a non-digitized format;
third party provided manuals satisfying the filtering; and
internally branded reference materials satisfying the filtering, the internally branded reference materials being specific to a group of first responders to which users of the first and second client devices are members.

14. The method of claim 1, wherein identifying an emergency response incident type at the first client device via the interface comprises:
a central incident command identifying the emergency response incident type via the first client device selected from one of:
a vehicle crash incident;
a hazardous materials incident;
a wild fire incident;
a house fire incident;
a chemical fire incident;
a natural disaster incident; and
a flooding incident.

15. The method of claim 14, further comprising:
displaying incident reporting forms and incident procedures at the interface of the first and second client devices based on the emergency response incident type identified by central incident command at the first client device.

16. The method of claim 1, wherein each of the first and second client devices each embodied within one of:
a tablet computing device; and
a hand-held smartphone.

17. A non-transitory computer readable storage medium having instructions stored thereon that, when executed by a processor of a system, the instructions cause the system to perform operations comprising:
establishing a first communications link between a first client device and the system over a network, the first client device being associated with a first emergency response person;
displaying an interface at the first client device from the system;
identifying an emergency response incident type at the first client device via the interface;
generating an incident response record at the system responsive to the identifying of the emergency response incident type at the first client device;
establishing a second communications link between a second client device and the system over the network, the second client device being associated with a second emergency response person;
displaying the interface at the second client device from the system;
displaying emergency response information at the interface of the second client device selected based on the emergency response incident type identified at the first client device, wherein the emergency response information is communicated from the system to the second client device over the network; and
receiving incident metrics at the system captured via the interface at the second client device and recording the incident metrics within the incident response record.

18. The non-transitory computer readable storage medium of claim 17, wherein the instructions cause the system to perform operations further comprising:
associating other client devices with the incident response record by authenticating the other client devices through the system hosted by a cloud service, wherein the association is determined based at least in part on association between each of the other client devices with the first client device having generated an incident response record at the system.

19. A system comprising:
a processor and a memory to execute instructions at the system;
a communications interface to receive a first communications link between a first client device remote from the system and the system over a network, the first client device being associated with a first emergency response person;
a web-server to transmit an interface to a display at the first client device;
the web-server to receive an indication of an emergency response incident type from the interface displayed at the first client device;
a database module to generate and store an incident response record at the system responsive to the indication by the first client device of the emergency response incident type;
the communications interface to receive a second communications link between a second client device remote from the system and the system over the network, the second client device being associated with a second emergency response person;
the web-server to transmit the interface to a display of the second client device;
the web-server to transmit emergency response information for display at the interface of the second client device, the emergency response information selected based on the indication by the first client device of the emergency response incident type, wherein the emergency response information is transmitted from the system to the second client device over the network;
the web-server to receive incident metrics captured via the interface displayed at the second client device; and
wherein the database module is to record the incident metrics within the incident response record.

20. The system of claim 19:
wherein the system operates within a host organization to provide a cloud based service to the first and second client device accessible over a public Internet;
wherein the host organization comprises at least the system, the web-server, and a database system;
wherein the database system communicably interfaced with the database module of the system; and
wherein the web-server is communicably interfaced to the first and second client devices via the public Internet to provide at least authentication services and transmission of the interface for display to the first and second client devices.
